(19) United States
(12) Patent Application Publication
(10) Pub. No.: US 2010/0201645 A1
(43) Pub. Date: Aug. 12, 2010

(54) DETERMINATION APPARATUS, DETERMINATION METHOD AND DATA STORAGE MEDIUM

(75) Inventor: Yuichi ASAMI, Tokyo (JP)

Correspondence Address: HOWARD & HOWARD ATTORNEYS PLLC, 450 West Fourth Street, Royal Oak, MI, 48067, US

(73) Assignee: KONAMI DIGITAL ENTERTAINMENT CO., LTD., Tokyo (JP)

(21) Appl. No.: 12/704,782

(22) Filed: Feb. 12, 2010

(30) Foreign Application Priority Data
Feb. 12, 2009 (JP) 2009-029507

(51) Int. Cl. G06F 3/048; G06F 3/041

(52) U.S. Cl. 345/173; 715/810; 715/856

(57) ABSTRACT

In the determination apparatus, the creation unit creates an image showing a virtual space. The first display unit displays images contained in the first display region of the virtual space. The second display unit displays images contained in the second display region of the virtual space. The input acceptance unit receives instruction input designating a position in the created image. When the position indicated by the instruction input is not contained in any of the fringe regions set in the first display region and the fringe regions set in the second display region, the determination unit set, in the virtual space, an pointing region with a first size. When the position indicated by the instruction input is in any of the fringe regions set in the first display region and the fringe regions set in the second display region, the determination unit sets, in the virtual space, an pointing region with a second size larger than the first size. Inside of the pointing region becomes the target indicated by the user.

### CROSS-REFERENCE TO RELATED APPLICATION

This application claims the benefit of Japanese Patent Application 2009-029507, filed on Feb. 12, 2009, the entire disclosure of which is incorporated by reference herein.

### TECHNICAL FIELD

This application relates generally to a determination apparatus, a determination method and a data storage medium to make it easier for the user to designate positions in the corner of a displayed screen.

### BACKGROUND

When playing games, a user (player) operates input devices such as a controller or a mouse. Depending on the game, it is possible to select objects or designate positions within the virtual space through the player's operation of these input devices. In recent years, game apparatus having a touch panel overlaid on the screen of the display have become popular. Players currently have the ability to select objects or designate positions by touching the touch panel with their finger or a pen.

For example, in the game system disclosed in Unexamined Japanese Patent Application KOKAI Publication No. 2006-252185, a collision detection area is established on an object (virtual pet). Collision detection is performed by using a straight line to connect the position of a virtual camera and the position touched by the user. When this straight line intersects the collision detection area, an indicating operation by the user is deemed a success. When the indicating operation is a success, the object is enlarged.

There is also a method for displaying a single image by partitioning it into a plurality of displays and a plurality of windows. For example, when the image is large, it can be divided into a top half and a bottom half. In addition, the displayed image could be divided into a left half and right half, or divided into three or more parts.

As noted above, it is possible to display a game screen by dividing it into a plurality of displays or a plurality of windows. When a game screen is divided and displayed in this manner, images that should have been displayed linked together are sometimes displayed separated. These erroneous game screen divisions make an object's position more difficult to identify when the object is near the boundaries or the corners of the divided screens. Accordingly, conventional games become extremely difficult when objects are positioned near the boundaries of these divisions. Therefore, it is desirable to have an apparatus, method, and storage medium that makes an object's position easier to designate when the object is located in the corners of the screens.

### SUMMARY

The present application discloses a determination apparatus, a determination method, and a data storage medium that facilitates positioning of objects in the corners of the displayed screen by a user. According to an embodiment of the present application a determination apparatus comprising a creation unit that creates an image is disclosed. Each of a plurality of display units displays a portion of the image in a display region having a fringe region. An input acceptance unit receives instruction input designating a position in a display region from among the plurality of display regions. A determination unit assigns a pointing region at the position designated by the instruction input received. The determination unit assigns a first size for the pointing region, when the position designated by the instruction input is not in the fringe region of the display regions. The determination unit preferably assigns a second size for the pointing region, when the position designated by the instruction input is in the fringe region of the display region. The second size is preferably larger than the first size. The determination apparatus of the present application preferably creates an image to be displayed to the user. For example, a game image that changes in accordance with instructions from the user (player) may be created. The determination apparatus may also create movie images, images showing presentation materials, etc. The type of image is not limited by the present application.

At least two display regions are set within this image. The part of the image that is contained in the display region is displayed in a display or window. The determination apparatus sets a plurality of display regions. In addition, the determination apparatus displays a portion of the image in the display or window corresponding to that display region.

The determination apparatus sets a plurality of neighboring display regions in the image. One of the neighboring display regions may be called the “first display region.” The other may be called the “second display region.” Typically, the display regions preferably touch each other. For example, two vertically neighboring display regions are set in a two-dimensional virtual space. The first display is set on the top side as viewed by the user. The second display is set on the bottom side as viewed by the user. The image within the first display region is preferably displayed in the first display. When the first display region and the second display region touch, a continuous image is displayed in the first display and second display.

The area near the boundary of the display regions is called the “fringe region,” or simply the “fringe.” For example, suppose that the display region is preferably a rectangle composed of four sides. The fringe region may be the region contained in the display region within a predetermined distance from these sides. However, the position, number, size and shape of the fringe regions may be arbitrarily defined.

The input devices used by the user may, for example, be a mouse, a controller, a touch panel, etc. The user can designate an arbitrary position within the image using such input devices. The determination apparatus preferably sets a pointing region around the designated position. The pointing region preferably is used to determine a target indicated by the user. In addition, the user designates a position by the instruction input. The pointing region is preferably a region that corresponds to this position. The shape of the pointing region is arbitrary and may be a polygon, circle, ellipse, etc.

By way of example, an enemy character object or an item object (hereinafter referred to as an “object”) may be positioned in a virtual space. Using an input device, the user designates the opponent to fight or an item to pick up. At this time, the indicated position is the position designated by the user using the input device. When the pointing region is only this indicated position (point), an error of even a few dots is not tolerated. Accordingly, the game's degree of difficulty becomes extremely high. Thus, the determination apparatus creates a pointing region surrounding this indicated position. The pointing region contains the position. When a portion (or all) of the object is inside the pointing region, the object is treated as the indicated target.

In addition, the determination apparatus may change the size and shape of the pointing region in accordance with the position indicated by the user. Specifically, when the indicated position is not contained in the fringe region, the indicated position is preferably set to a first size. On the other hand, when the indicated position is contained in the fringe region, the pointing region is preferably set to a second size that is preferably larger than the first size. Sizes are typically compared through surface area, dot count, pixel count, etc.

In other words, when the position designated by the user is contained in the fringe region, the pointing region used in selecting the indicated target preferably becomes larger. As a result, it becomes easier for indicated target objects to fall within the pointing region. Accordingly, the user can more easily designate positions near the fringe region, that is to say positions in the corners of the screen. In other words, it becomes easier to select objects, etc., residing in the fringe regions of the screen. In general, the user can readily perceive objects near the center of the screen. On the other hand, there are times when only a portion of objects near the corners of the screen is displayed. Alternatively, there are cases when an object moves and repeatedly disappears from the screen and then reappears on the screen. Accordingly, there is a possibility that the user may have difficulty understanding the position of the object. Consequently, there is a fear that the game may become extremely difficult due to the corners of the screen (the fringe region in the display region). However, the pointing region is preferably enlarged near the fringe regions. As a result, it is possible to control the degree of difficulty of the game.

The determination unit assigns the first size and a first shape for the pointing region when the position designated by the instruction input is not in the fringe region. Furthermore, the determination unit assigns the second size and a second shape for the pointing region when the position designated by the instruction input is in the fringe region. That is to say, the determination apparatus may change not just the size of the pointing region but the shape as well. This change is in preferably in accordance with the position indicated by the user. For example, a case where the position indicated by the user is contained in a fringe region established within the display region will be described hereafter. By changing the shape of the display region, the pointing region becomes larger the closer the indicated position is to the boundary of the display region. As a result, indicated target objects near the boundaries more readily fall within the pointing region. Accordingly, with the present invention, the user can more easily designate positions near the fringe regions, that is to say positions in the corners of the screen.

The plurality of display units of the determination device preferably contains a first display unit and a second display unit that are adjacent to each other. The first display unit preferably displays a first display region having a first fringe region set within a predetermined first distance from an edge of the first display unit. The edge of the first display region is preferably the edge closest to a second display region displayed on the second display unit. The second display unit preferably displays a second display region having a second fringe region set within a predetermined second distance from an edge of the second display unit. The edge of the second display region is preferably the edge closest to a first display region displayed on the first display unit. The determination apparatus preferably assigns the second size for the pointing region when the position designated by the instruction input is included in either of the first fringe region or the second fringe region.

One display unit, or one window, may be assigned for each display region. Preferably, when the first and second display regions are displayed on the display units or the windows in the real world, the positional relationship between them in the real world corresponds to what is in the virtual world.

For example, where the first and second display regions are adjacent to each other, a first fringe region is set within the first display region so as to be within a predetermined distance from one edge of the first display region which is closest to an edge of the second display region, i.e. the first fringe region is adjoining to the second display region. A second fringe region is set within the second display region so as to be within a predetermined distance from one edge of the second display region which is closest to an edge of the first display region; i.e. the second fringe region is adjoining to the first display region.

Where the position indicated by the user is contained within the first fringe region or the second fringe region, the determination unit can change the size and shape of the pointing region. That is, where the position indicated by the user is close to the border between the first display region and the second display region, the determination unit can resize the pointing region into a second size. On the other hand, when the position pointed by the user is within a fringe region other than the first and the second fringe regions, the size or shape of the pointing region may not be changed. As a result of enlarging size of pointing region occurring where the user-pointed position is contained within the first or the second fringe region, a target object that user is intending to point can easily be caught within the pointing region even if it is closely on the border of the first and the second display regions. According to the embodiment, the user can more easily to point a position at the margin of the screen.

An object image selectable by the user may be contained in the created image. In addition, the determination apparatus may be further provided with an output unit that outputs as the selection results information indicating this object image when this object image and the pointing region overlap.

As noted above, the object image is an image indicating an item object or an enemy character object positioned in the virtual space. When the object image is in the pointing region, the object image is preferably treated as being selected by the user. In addition, the object image may be an image indicating a button linked to a predetermined process. In this case, when the object image is contained in the pointing region, the process linked to that object image is considered to be selected by the user.

For example, the case where a plurality of buttons are positioned inside the display region will be described hereafter. The image is displayed across a plurality of displays or windows. The user can select an arbitrary button. Among the buttons are some positioned near the center of the display. The user can easily perceive the positional relationship of the buttons near the center. On the other hand, some of the buttons are positioned in the corners of the display (that is to say, in the fringe regions set within the display region). The closer a button is to the boundary of the screen, the more difficult it is for the user to perceive the positional relationship of the button. In addition, it is difficult for the user to select buttons near the boundary of the screen. However, with the present invention the pointing region becomes larger when the position indicated by the user is contained in the fringe region. Accordingly, the object image (button image) more readily falls in the pointing region. As a result, the user can more easily designate a position near the fringe region, that is to say a position in a corner of the screen. As noted above, the pointing region is used in the designation of the indicated target.

A pointer image indicating the object selected by the user may be contained in the image created. Furthermore, the output unit may display the pointer image at a predetermined size when the position of the pointer image is not in any of the fringe regions displayed by the plurality of display units. Furthermore, the output unit may display the pointer image at a predetermined enlarged size when the position of the pointer image is in any of the fringe regions.

The pointer image may be a mark showing the position the user is currently indicating. In general, the pointer image is called a mouse cursor, a mouse pointer, etc. In a preferred embodiment, not only the size of the pointing region but the size of the pointer image as well can be changed in accordance with the position indicated by the user. For example, when the position indicated by the user is contained in the fringe region established in the display region, the pointer image is enlarged. Accordingly, in a preferred embodiment the pointer image becomes larger if the pointer image is moved near the fringe region. As a result, the user can easily perceive the position currently being indicated. Furthermore, the user can easily designate a position near the fringe region, that is to say, a position in the corners of the screen. The closer it is to the boundary of the display region, the larger the pointer image may become.

An object image selectable by the user may be contained in the generated image. The determination unit may assign a first size for the pointing region when the position designated by the instruction input is not contained in the fringe region. The determination unit may assign a second size for the pointing region when the position designated by the instruction input is contained in the fringe region. Moreover, the determination unit may assign a first size for the pointing region when the position designated by the instruction input is contained in the fringe region and the position of the object is not contained in the fringe region.

That is to say, even when the position indicated by the user is contained in the fringe region, the size of the pointing region does not change if the object image is not contained in this fringe region. As noted above, the fringe region is set within the display region. The object image may be selected by the user. When the object image is contained in the fringe region, the pointing region is enlarged. When the object image is not contained in the fringe region, the determination apparatus can omit the process for changing the pointing region.

The determination apparatus may include a game advancer that advances the game in the virtual space in accordance with received instruction input, and an estimator that estimates the user's skill level in this game. Furthermore, the determination unit may assign a first size for the pointing region when the position designated by the instruction input is not contained in the fringe region. The determination unit may assign a second size for the pointing region when the position designated by the instruction input is contained in the fringe region and the estimator estimates that the user's skill level is below a predetermined level. In addition, the determination unit may assign the first size for the pointing region when the position designated by the instruction input is contained in the fringe region and the estimator estimates that the user's skill level is at a predetermined level or higher.

As noted above, in a preferred embodiment, the image is preferably generated by the determination apparatus. This image may be, for example, the image of a game the user (player) is playing. The determination apparatus preferably advances the game based on input from the user. The determination apparatus may estimate the user's skill level in the game based on the input operations from the user. For example, when the score attained by the user is below a predetermined value, the user may be deemed a novice. In addition, when the score is at or above a predetermined level, the user may be deemed not to be a novice. Furthermore, the pointing region is preferably enlarged when the user is estimated to be a novice and the position indicated by the user is contained in the fringe region. Accordingly, the determination apparatus may match operability to the user's skill. As a result, it is possible for a user to operate the game easier than conventional games.

Parameters to estimate the user's skill level may include, for example, the number of times that the game has been played, the time of day the game was played (or is being played), the time slot when the game was played (or is being played), the frequency of playing the game, or other data exhibiting the user's history regarding the game.

The determination method according to a preferred embodiment is a determination method executed by a determination apparatus comprising a creation unit, a plurality of display units, an input acceptance unit and a determination unit, and is provided with a creation step, a display step, a receiving step and a determination step. In the creation step, the creation unit creates an image to be exhibited to the user. In the display step, each of the plurality of display units displays the display a portion of the image in a display region having a fringe region. In the receiving step, the input acceptance unit receives instruction input designating a position in the display region. In the determination step, the determination unit assigns the pointing region at the plurality of display regions at the position designated by the instruction input received. The determination unit assigns a first size for the pointing region when the position designated by the instruction input is not contained in of the fringe regions set in the display region displayed by the plurality of display units. Also, the determination unit assigns a second size for the pointing region when the position designated by the instruction input is contained in the fringe region of the display region. Furthermore, the second size is preferably larger than the first size.

In a preferred embodiment, when the user designates a position contained in the fringe region, the pointing region used in selecting the indicated target is enlarged. Because the pointing region becomes larger, the indicated target object more readily falls in the pointing region. This makes it easier for the user to designate positions near the fringe regions, that is to say positions in the corners of the screen.

The program stored in the data storage medium according to a preferred embodiment causes a computer to function as a creation unit, a plurality of display units, an input acceptance unit and a determination unit. The creation unit preferably creates an image that should be exhibited to the user. Each of the plurality of display units displays a portion of the image. The input acceptance unit preferably receives the instruction input designating positions within the image. The determination unit preferably assigns the pointing region corresponding to the position designated by the received instruction input. The determination unit assigns a first size for the pointing region containing the designated position, when the position designated by the instruction input is not contained in any of fringe regions of the display regions displayed by the plurality of display units. Also, the determination unit assigns a second size for the pointing region containing the designated position, when the position designated by the instruction input is contained in any of fringe region of the display region displayed by the plurality of display units. Furthermore, the second size is preferably larger than the first size.

In a preferred embodiment, a computer can be made to function as the determination apparatus that operates as described above. In addition, the data storage medium according to a preferred embodiment may be a data storage medium readable by a computer, such as a compact disc, a flexible disk, a hard disk, an optomagnetic disc, a digital videodisc, a magnetic tape, a semiconductor memory, etc. The above-described data storage medium can be distributed and sold independent of the computer.

In a preferred embodiment, it is possible to provide a determination apparatus, a determination method and a data storage medium, suitable for making it easier for the user to designate positions in the corners of the screen displayed.

### BRIEF DESCRIPTION OF THE DRAWINGS

A more complete understanding of this application can be obtained when the following detailed description is considered in conjunction with the following drawings, in which:

FIG. 1 is a drawing showing the schematic composition of a typical data processing apparatus with which the determination apparatus according to the present invention is realized;

FIG. 2 is a drawing used to explain the functional composition of the determination apparatus;

FIG. 3A is a drawing showing a virtual space;

FIG. 3B is a drawing showing a first display region;

FIG. 3C is a drawing showing a second display region;

FIG. 4A is a drawing showing an example of a fringe region;

FIG. 4B is a drawing showing an example of a fringe region;

FIG. 4C is a drawing showing an example of a fringe region;

FIG. 4D is a drawing showing an example of a fringe region;

FIG. 5A is an example of the composition of an image exhibiting the first display region;

FIG. 5B is an example of the composition of an image exhibiting the second display region;

FIG. 6A is an example of the composition of an image exhibiting the first display region;

FIG. 6B is an example of the composition of an image exhibiting the second display region;

FIG. 7 is a flowchart depicting a series of preferred steps for a preferred embodiment of the determination process;

FIG. 8A is a drawing showing an example of the composition of the first window and the second window;

FIG. 8B is a drawing showing an example of the composition of the first display and the second display;

FIG. 8C is a drawing showing the first display region and the second display region;

FIG. 9 is a flowchart depicting another series of preferred steps of a preferred embodiment of the determination process;

FIG. 10A is a drawing showing an example of the pointing region when the pointer image is within the fringe region in a second preferred embodiment;

FIG. 10B is a drawing showing an example of the pointing region when the pointer image is within the fringe region in the second preferred embodiment;

FIG. 11 is a drawing depicting the structure of the determination apparatus in a third preferred embodiment;

FIG. 12 is a drawing showing an example of the output of a message when the object is selected in the third preferred embodiment;

FIG. 13 is a drawing used to explain the change in size of the pointer image in a fourth preferred embodiment;

FIG. 14A is a drawing showing changes in the enlargement ratio of the pointer image in the fourth preferred embodiment;

FIG. 14B is a drawing showing changes in the enlargement ratio of the pointer image in the fourth preferred embodiment;

FIG. 15A is a drawing showing the virtual space in a fifth preferred embodiment;

FIG. 15B is a drawing showing the first window and the second window;

FIG. 16A is a drawing showing the virtual space in a sixth preferred embodiment;

FIG. 16B is a drawing showing the first window and the second window;

FIG. 17A is a drawing showing the virtual space in a seventh preferred embodiment;

FIG. 17B is a drawing showing the first display and the second display;

FIG. 18A is an example of the composition of an image exhibiting the first display region;

FIG. 18B is an example of the composition of an image exhibiting the second display region;

FIG. 19 is a drawing showing an example of the arrangement of the first display region and the second display region in the virtual space;

FIG. 20A is an example of the composition of an image exhibiting the first display region;

FIG. 20B is an example of the composition of an image exhibiting the second display region; and

FIG. 21 is a drawing used to explain the functional composition of the determination apparatus according to an eighth preferred embodiment.

### DETAILED DESCRIPTION

A first preferred embodiment will be described hereinafter. In order to facilitate understanding in the below description, embodiments are disclosed using a data processing apparatus for games, but the below embodiments are for purposes of explanation and are intended to be illustrative and not limiting. Accordingly, one skilled in the art can utilize these embodiments by substituting the various elements or all elements with equivalent parts, but such embodiments also fall within the scope of the present invention.

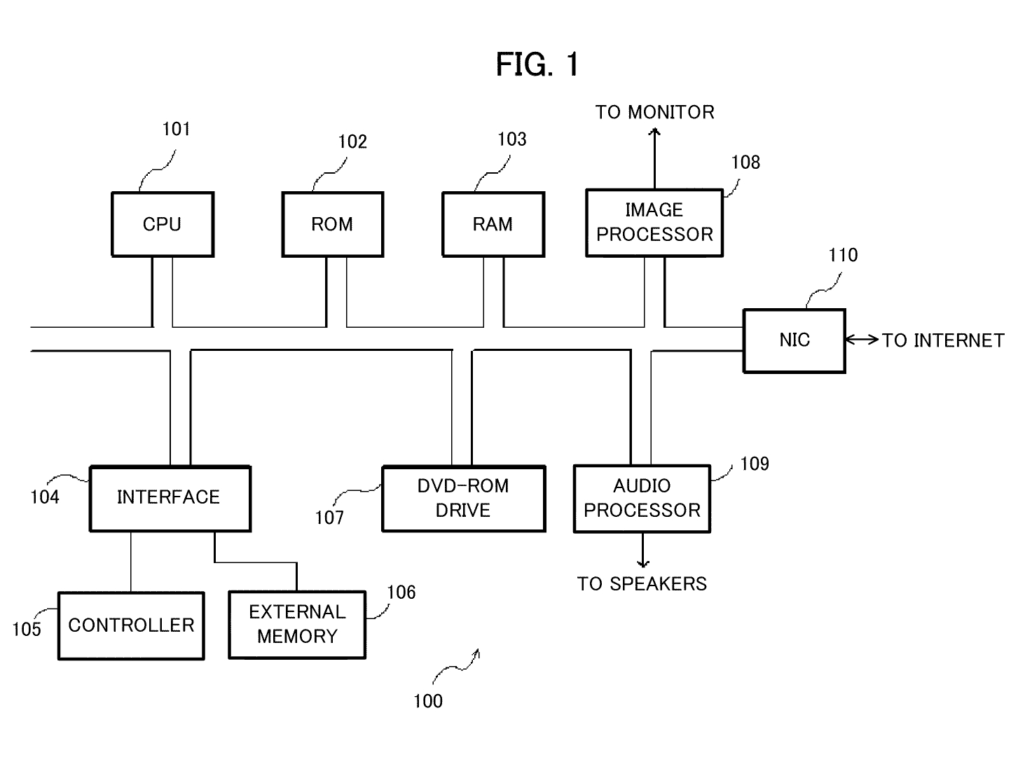

FIG. 1 is a drawing showing the schematic composition of a typical data processing apparatus 100 that achieves the functions of the determination apparatus according to the present application by executing a program. The embodiment will be described hereinafter with reference to this drawing.

The data processing apparatus 100 preferably includes a CPU (Central Processing Unit) 101, a ROM (Read Only Memory) 102, a RAM (Random Access Memory) 103, an interface 104, a controller 105, an external memory 106, a DVD-ROM (Digital Versatile Disk—Read Only Memory) drive 107, an image processor 108, an audio processor 109 and a NIC (Network Interface Card) 110.

First, the DVD-ROM on which a game program and data may be stored, may be loaded into the DVD-ROM drive 107. Next, the power source of the data processing apparatus 100 may be turned on. By turning on the power source, the program may be executed. This is one example of how the determination apparatus according to this embodiment is preferably realized.

The CPU 101 preferably controls the whole operation of the data processing apparatus 100. The CPU 101 is preferably connected to and preferably exchanges control signals and data with the various constituent elements. In addition, the CPU 101 can execute operations on a register (unrepresented) using an Arithmetic Logic Unit (“ALU”) (unrepresented). The register may be, for example, a memory area capable of high-speed access. The operations are preferably arithmetic operations such as addition, subtraction, multiplication and division; logical operations such as OR, AND and NOT operations; bit operations such as bitwise OR, bitwise AND, bitwise NOT, bit shift, bit rotation, etc; and so forth. Furthermore, the CPU 101 may be adapted for high-speed operations in order to respond to multimedia processing. In addition, a coprocessor may assist executing these operations. Operations for responding to multimedia processing include saturation operations such as the four arithmetical operations, trigonometric functions, vector operations, etc.

An Initial Program Loader (“IPL”), which preferably executes immediately after the power source is turned on, may be stored in the ROM 102. By executing the IPL, the program stored on the DVD-ROM may be read into the RAM 103, which is one example of how execution of the program by the CPU 101 may be started. An operating system preferably controls whole operation of the data processing apparatus 100. The operating system program and various data may be recorded in the ROM 102.

The RAM 103 may be used for temporarily storing data and programs. In the RAM 103 data and programs read from the DVD-ROM may be maintained, as well as any other data used for the progress of the game or chat communications. The CPU 101 may create a variable region in the RAM 103 and execute operations directly using the ALU on the values stored in these variables. In addition, the CPU 101 may also temporarily store, in the register, the values stored in the RAM 103. Following this, the CPU 101 may perform operations on the register and execute processes such as writing the operation results to the memory.

The controller 105 is preferably operably connected via the interface 104. The controller 105 preferably receives operational input from the player while a user is playing the game. For example, the game may be a dance game, a soccer game, etc. A plurality of controllers 105 may be connected to the interface 104.

The external memory 106 is preferably releasably connected via the interface 104. Various data is preferably recorded on the external memory 106. The data may indicate the playing status of the game (past results, etc.), the progress of the game, the log (record) of game chat communications using a network, etc. The player can appropriately record this data on the external memory 106 through operational input via the controller 105.

A DVD-ROM may be loaded in the DVD-ROM drive 107. Programs for realizing a game and image data and voice data accompanying the game may be recorded on the DVD-ROM. Through control by the CPU 101, the DVD-ROM drive 107 may execute a reading process on the DVD-ROM loaded therein. The DVD-ROM drive 107 reads out the necessary programs and data. Programs and data read from the DVD-ROM may be temporarily stored in the RAM 103, etc.

The image processor 108 preferably processes data read from a storage-medium, such as, for example, a DVD-ROM. During processing, the image processor 108 preferably works in conjunction with the CPU 101 and an attached image operation processor (unrepresented). The processed data may be stored in frame memory (unrepresented). The frame memory may be mounted in the image processor 108. The image processor 108 preferably converts data stored in the frame memory into a video signal at predetermined synchronization timing. Next, the image processor 108 preferably outputs image data to a monitor (not shown) connected to the image processor 108. Through this, various image displays may be enabled.

The image processor 108 can execute various high-speed operations for creating images. The various operations may be, for example, two-dimensional image overlay operations, transparent operations such as a blending, various saturation operations, etc.

In addition, image processor 108 preferably appends various texture data to polygon data positioned in the virtual three-dimensional space. The image processor 108 preferably renders this polygon data using the Z-buffer method. The rendering image may be a bird's-eye view of the polygon arranged in the three-dimensional virtual space from a predetermined viewing position. Rendering the image with the Z-buffer method makes high-speed execution of the image rendering operations possible.

Furthermore, font data preferably defines the shape of the characters. Through the cooperative action of the CPU 101 and image processor 108, a character string may be drawn as a two-dimensional image in the frame memory following the font data. In addition, drawing the character string on various polygon surfaces is also possible.

In addition, image processor 108 can prepare data such as game images in the DVD-ROM and this can be expanded into the frame memory, which allows display of the game situation, etc., on the screen.

The audio processor 109 preferably converts audio data read from a storage-medium, such as, for example, the DVD-ROM, into an analog audio signal. Furthermore, the audio processor 109 may output the audio signal to connected speakers (unrepresented). In addition, the audio processor 109 may create sound effects and music data that may be reproduced during the course of the game in conjunction with the CPU 101 and may output these corresponding sounds to the speakers.

The audio data, which may be recorded on the DVD-ROM, may be Musical Interface Digital Instrument (“MIDI”) data. In this case, the audio processor 109 may convert the MIDI data into Pulse Code Modulation (“PCM”) data with references to sound source data. In addition, if the audio data has been compressed, the audio processor 109 preferably decompresses the audio data and converts the audio data to PCM data. The compressed sound source data may be in Adaptive Differential Pulse Code Modulation (“ADPCM”) format, Ogg Vorbis format, etc. The audio processor 109 preferably executes Digital/Analog conversion of the PCM data with a timing corresponding to the sampling frequency. The audio processor 109 preferably outputs the converted data to an audio output device, such as, for example, speakers, enabling audio output.

The NIC 110 preferably interfaces the data processing apparatus 100 to a computer communication network (unrepresented), such as, for example, the Internet. The NIC 110 may be an interface (unrepresented) that accomplishes mediation with the CPU 101 and equipment for connecting to the Internet. Equipment for connecting to the Internet may be a device adhering to the 10Base-T/100Base-T standard used when assembling a Local Area Network (“LAN”); furthermore, the equipment may be an Internet enabled analog modem using phone circuits, an Integrated Services Digital Network (“ISDN”) modem, an Asymmetric Digital Subscriber Line (“ADSL”) modem, an Internet enabled cable modem using cable television circuits, etc.

The data processing apparatus 100 may also be configured to allow the large-capacity external memory apparatus to fulfill the same functions as the memory and DVD-ROM loaded in the DVD-ROM drive 107. The memory may be the ROM 102, the RAM 103 or the external memory 106. In addition, the large-capacity external memory apparatus may be a hard disk etc.

A preferred embodiment of the determination apparatus 200 that may be realized through the data processing apparatus 100 having the above structure will be described hereinafter.

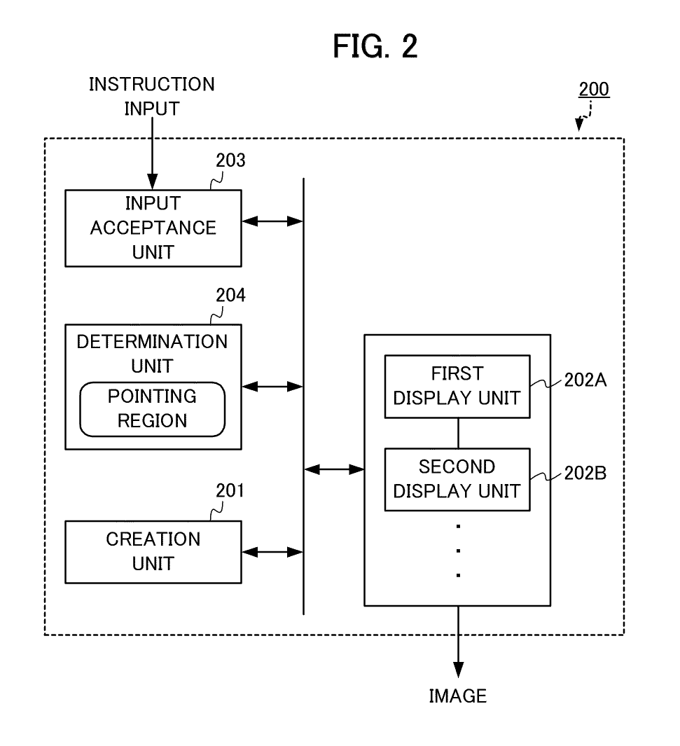

FIG. 2 is a drawing depicting the preferred elements of the determination apparatus 200. The determination apparatus 200 preferably includes a creation unit 201, a plurality of display units 202 (two in this embodiment—a first display unit 202A and a second display unit 202B), an input acceptance unit 203 and a determination unit 204.

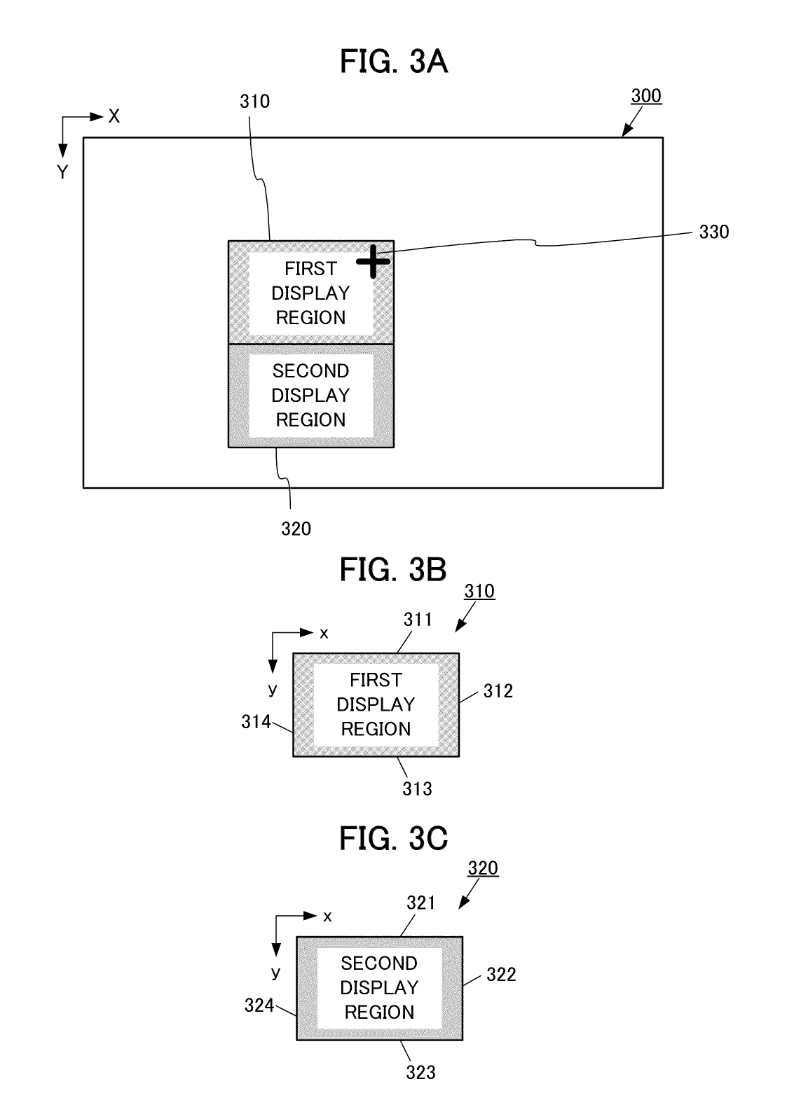

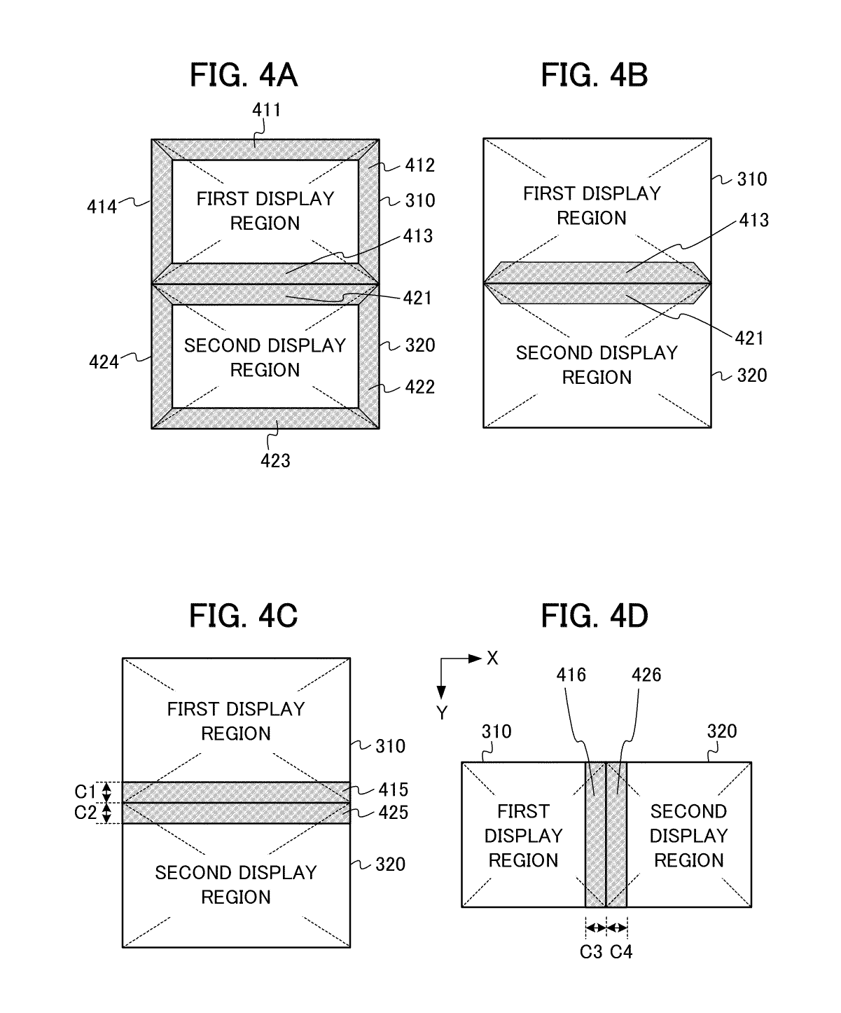

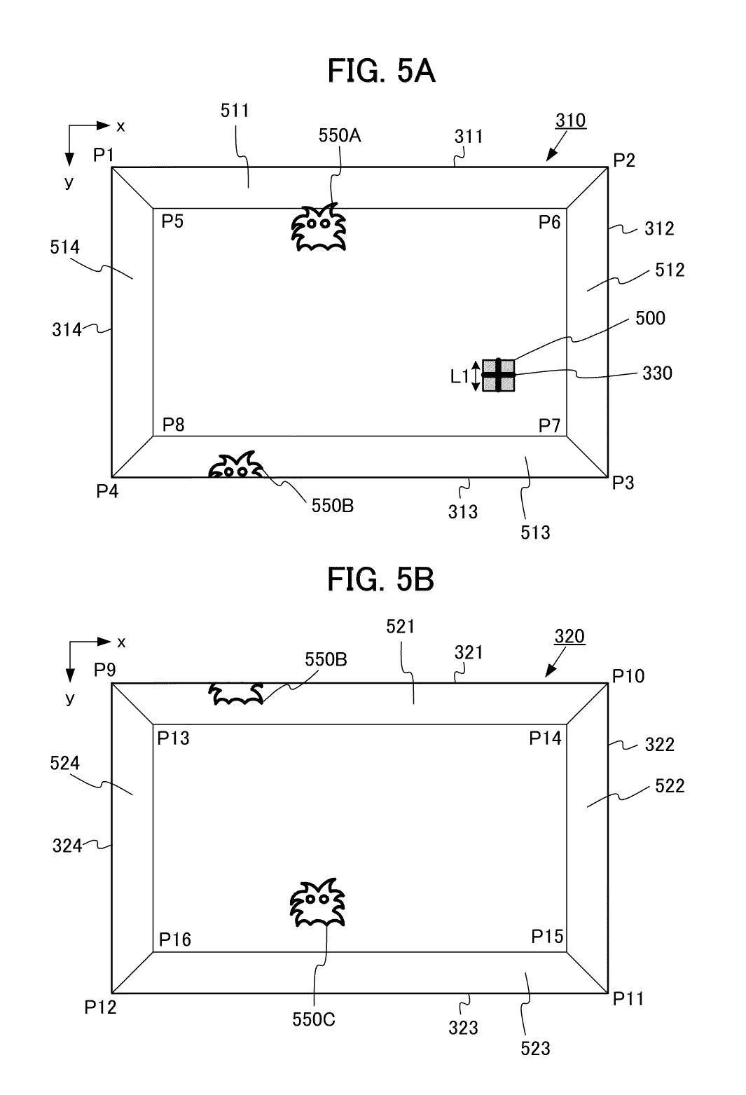

FIGS. 3A-3C show a preferred virtual space 300 handled by the determination apparatus 200. FIGS. 4A-4D are drawings used to illustrate the fringe regions (described in detail hereinafter) preferably assigned within the display regions which are assigned in the virtual space 300. FIGS. 5A and 5B are drawings used to show illustrative components of the screen displayed on the monitor preferably connected to the determination apparatus 200.

The creation unit 201 preferably creates an image that may be displayed, for example, to a user of the determination apparatus 200. The user or player may play the game by manipulating the controller 105. In this embodiment, the creation unit 201 may create images of a game proceeding in the virtual space 300. However, the images created by the creation unit 201 are not limited to images of a game. The created images may be arbitrary images, such as images of a movie, images showing presentation materials, etc. The CPU 101 working in conjunction with the image processor 108, preferably functions as the creation unit 201.

As discussed above, the creation unit 201 preferably creates images. Furthermore, the display region is preferably assigned as described below. The first display unit 202A and second display unit 202B display the created images on the monitor that are preferably contained within the display region. The CPU 101 assigns a plurality of display regions within the virtual space 300.

The first display unit 202A preferably displays images showing the contents of the first display region 310. In addition, the second display unit 202B displays images showing the contents of the second display region 320. The CPU 101 working in conjunction with image processor 108, preferably functions as the first display unit 202A and the second display unit 202B.

The determination apparatus 200 of this preferred embodiment may include two display units and two display regions assigned within the virtual space 300. However, the determination apparatus 200 may include three or more display units. If three or more display units are included, three or more display regions may be assigned within the virtual space 300.

The display regions are described in detail hereinafter with reference to FIGS. 3A-3C. The game executed by the determination apparatus 200 preferably handles the virtual space 300. In the virtual space 300, the CPU 101 preferably assigns the first display region 310 corresponding to the first display unit 202A, as shown in FIG. 3A. In addition, the CPU 101 also preferably assigns the second display region 320 corresponding to the second display unit 202B. The pointer image 330 is preferably contained in the image showing the virtual space 300.

The virtual space 300 handled in this embodiment may be a two-dimensional space, but a three-dimensional space may also be adopted. The object may be positioned within the virtual space 300. In addition, the various perspectives of the image may be set within the virtual space 300. The displayed image is preferably projected on a predetermined projection surface that is visible from a user's perspective (the direction of the virtual camera). The first display unit 202A and the second display unit 202B preferably display the image.

By way of example, suppose the determination apparatus 200 is connected to a single monitor (hereinafter also called the “display”). Two neighboring image areas (so-called “windows”) may exist in the screen displayed on the monitor. In the first window, an image showing the contents of the first display region 310 may be displayed. In addition, in the second window an image showing the contents of the second display region 320 may be displayed.

Alternatively, the determination apparatus 200 may be connected to two neighboring monitors. For example, the image showing the contents of the first display region 310 may be displayed on one monitor, while the image showing the inside of the second display region 320 may be displayed on the other monitor.

The determination apparatus 200 preferably predefines a global coordinate system, such as, for example, the X-Y coordinate system shown in FIG. 3A, in the virtual space 300. The determination apparatus 200 preferably expresses the position of the first display region 310 and the position of the second display region 320 using position coordinate values under the global coordinate system. The CPU 101 may move the first display region 310 and the second display region 320 to different positions.

By way of example, a player may input instructions that alter the position of the display regions in the virtual space 300. Specifically, the CPU 101 may change the position of the first display region 310 and the position of the second display region 320. When the first display region 310 and the second display region 320 move, the images displayed in the window or on the monitor change. This movement is generally known as “scrolling.”

The shape of the first display region 310 of this embodiment may be a rectangle enclosed by four sides 311-314, as shown in FIG. 3B. Similarly, the shape of the second display region 320 may be a rectangle enclosed by four sides 321-324, as shown in FIG. 3C.

The first display region 310 and the second display region 320 preferably neighbor one another in the virtual space 300. Typically, the first display region 310 and the second display region 320 may also touch or overlap each other. In the example of FIG. 3A, the side 313 of the first display region 310 is shown overlapping side 321 of the second display region 320. However, the first display region 310 need not touch the second display region 320. The first display region 310 may be separate from the second display region 320 by a predetermined distance, or may have overlapping areas.

The first display region 310 and the second display region 320 preferably neighbor each other in virtual space 300. The following are combinations of neighboring sides. Side 311 of the first display region 310 may neighbor the side 323 of the second display region 320. Side 312 of the first display region 310 may neighbor the side 324 of the second display region 320. Side 313 of the first display region 310 may neighbor the side 321 of the second display region 320. Finally, side 314 of the first display region 310 may neighbor the side 322 of the second display region 320.

The first display region 310 and the second display region 320 of this embodiment may have the same shape and the same size. However, their shapes and sizes may differ.

Next, the user may input instructions that designate a position in the image showing the virtual space 300. The input acceptance unit 203 preferably receives the instruction input. The CPU 101 working in conjunction with the controller 105, preferably functions as the input acceptance unit 203.

By way of example, the pointer image 330 may be displayed on the monitor. The player may move the position of the pointer image 330 by pressing up, down, left and right buttons on the controller 105. The controller 105 may send instructions to the determination apparatus 200 to position the pointer image 330 in the first display region 310 or the second display region 320. In other words, the user may designate an single arbitrary position within the first display region 310 or the second display region 320.

The determination apparatus 200 preferably predefines a local coordinate system, such as, for example, the x-y coordinate system in FIGS. 3B and 3C, in the first display region 310 and the second display region 320. The position of the pointer image 330 is given using the position coordinate value under the local coordinate system. The CPU 101 may determine the position of the pointer image 330 in the virtual space 300 using a coordinate conversion from the local coordinate system to the global coordinate system. The CPU 101 may move the pointer image 330 within the first display region 310 or within the second display region 320.

The user may designate the position of the pointer image 330 by entering instruction input. FIG. 3A shows an illustrative pointer image 330 shaped as a cross. The point where the horizontal line and the vertical line of the cross intersect may be the position indicated by the user. However, the shape and size of the pointer image 330 is arbitrary and is not limited to the cross that is illustrated in FIG. 3A. The pointer image 330 is generally known as the mouse cursor, mouse pointer, etc.

As noted above, the input acceptance unit 203 preferably receives instruction input. The determination unit 204 preferably assigns the pointing region in the virtual space 300 at the position designated by the instruction input. The CPU 101 working in conjunction with the image processor 108, preferably functions as the determination unit 204.

The pointing region 500 may have a predetermined size and a predetermined shape containing the pointer image 330 at a position indicated by the user, as shown in FIG. 5A. As noted above, the user may indicate the position to the determination apparatus 200. The pointing region 500 may be the region designating the target by instructions from the user.

As noted in the example above, if the position designated by, for example, a user is the point where the horizontal line and the vertical line of the illustrative cross intersect, the margin of error for designating the position would be within one to several dots. However, by creating the pointing region 500, a higher margin of error is tolerated for designating the position as measured by the width of the pointing region 500.

For example, an image of a character object 550 (hereinafter “object 550”) is positioned in the first display region 310 and/or the second display region 320. Referring to the example of FIGS. 5A-5B, the images of the illustrative character objects 550A, 550B and 550C are shown. If the object 550 is positioned within the pointing region 550, the determination apparatus 200 may acknowledge that the object 550 has been selected. The determination apparatus 200 may determine that the object 550 has been selected, if the object 550 moves within pointing region 500. As noted in the example above, if the region to designate the target is limited to a point where the horizontal line and the vertical line of the illustrative cross intersect, the margin of error for designating the positions would be within one to several dots.

Alternatively, the determination that an object 550 has been selected may be made when the following two conditions are satisfied: the object 550 exists within the pointing region 500; and a predetermined indication operation has been performed (e.g., a mouse click operation, etc.).

The object 550 in the virtual space 300 may also exist simultaneously in both the first display region 310 and the second display region 320. This situation may arise due to the positional relationship among the object 550, the first display region 310 and the second display region 320 in the virtual space 300. FIGS. 5A and 5B demonstrate a working example using object 550B.

For example, the shape of the pointing region 500 may be a polygon having the position of the pointer image 330 as the center point or centroid point. The shape of the pointing region 500 may be any desired shape. For example, the pointing region 500 may be shaped as a circle, an ellipse, or any arbitrary shape, the center (or centroid) of which is preferably the position of the pointer image 300.

The position of the pointing region 500 may be given by coordinate values. The coordinate system may be the global coordinate system defined in the virtual space 300, the local coordinate system defined in the first display region 310 or the local coordinate system defined in the second display region 320.

The CPU 101 may change the size and shape of the pointing region 500 in accordance with the position of the pointer image 330.

As noted above, the CPU 101 preferably defines a fringe region for each display region. When the position of the pointer image 330 is not contained within the fringe region, the CPU 101 preferably assigns a first size for the pointing region 500. On the other hand, when the position of the pointer image 330 is contained in the fringe region, the CPU 101 preferably assigns a second size for the pointing region 500. The second size preferably has a larger surface area than the first size.

By way of example, FIG. 4A shows an illustrative first display region 310 composed of four sides. FIG. 4A shows four regions 411-414 bordering these sides. Each of the illustrative regions 411-414 may be a fringe region of the illustrative first display region 310. Alternatively, the four regions 411-414 together may be defined as a unified fringe region.

Similarly, FIG. 4A shows the illustrative second display region 320 having four sides. Four regions 421-424 are shown bordering these sides. Each of the illustrative regions 421-424 is shown as a fringe region of the second display region 320. Alternatively, the four regions 421-424 together may be defined as a single fringe region.

FIG. 4B is another example showing how neighboring regions alone may be defined as fringe regions. In this example, among the regions 411-414 and the regions 421-424, only the region 413 and the region 421 would be fringe regions.

In the example of FIG. 4C, neighboring regions with a set width may be defined as fringe regions. As shown in FIG. 4C, the region 415 of width C1 in the first display region 310, which is shown abutting second display region 320, may be the fringe region of the first display region 310. In addition, the region 425 of width C2 in the second display region 320, which is shown, abutting the first display region 310, may be the fringe region of the second display region 320. C1 and C2 may be any value greater than zero.

The first display region 310 and the second display region 320 may neighbor each other in the Y-axis direction, as shown in FIGS. 4A-4C. In addition, the first display region 310 and the second display region 320 may neighbor each other in the X-axis direction, as shown in FIG. 4D. Furthermore, referring to FIG. 4D, the region 416 of width C3 in the first display region 310, which is shown abutting the second display region 320, may be the fringe region of the first display region 310. In addition, the region 426 of width C4 in the second display region 320, which is shown abutting the first display region 310, may be the fringe region of the second display region 320. C3 and C4 may be any value greater than zero.

When the pointer image 330 of this embodiment is not in a fringe region, the CPU 101 preferably sets the size of the pointing region 500 to a predetermined first size, as shown in the example of FIG. 5A. In the example of FIG. 5A, the area not in a fringe region is shown enclosed by vertices P5, P6, P7 and P8. In FIG. 5A, the pointing region 500 is shown set to the shape of a square of side length L1.

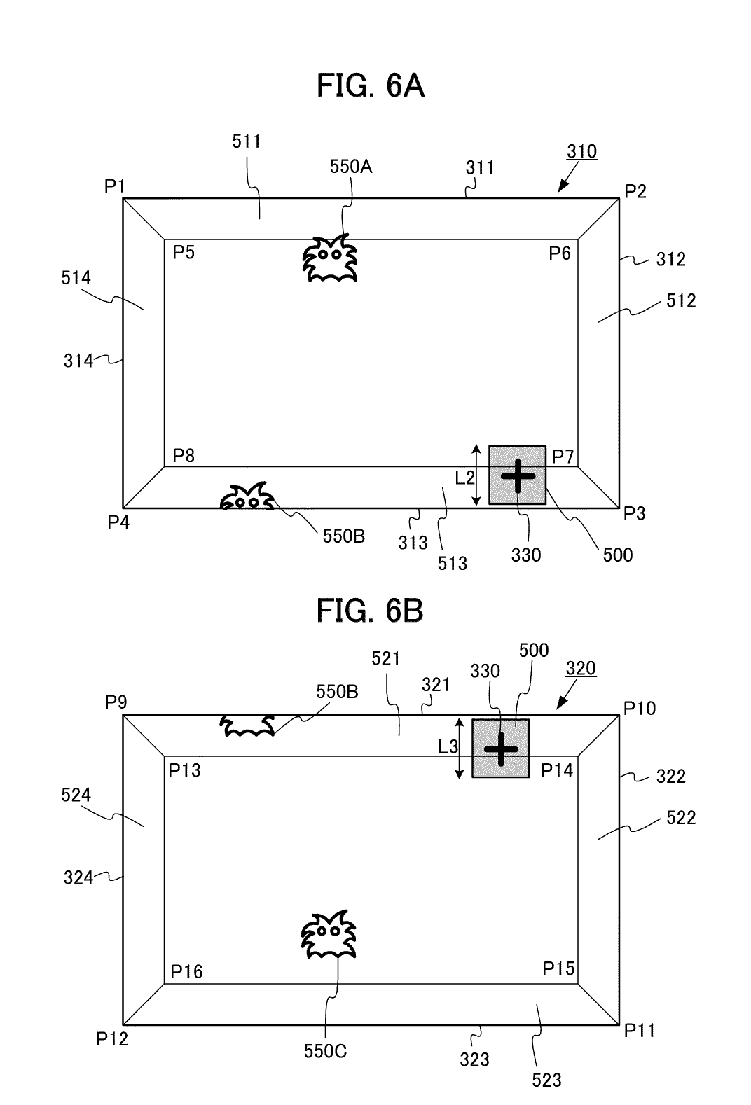

In contrast, when the pointer image 330 is in a fringe region, the CPU 101 preferably sets the size of the pointing region 500 to a predetermined second size, as shown in the example of FIG. 6A. The fringe region in the example of FIG. 6A is shown set within the first display region 310. In FIG. 6A, the pointing region 500 is shown set to the shape of a square of side length L2 (L1<L2).

On the other hand, as shown in FIG. 6A, four fringe regions 511-514 are set in the first display region 310. Each of the fringe regions 511-514 is also called a unit region as a constituent of the first display region 310. The unit region may be set within a first predetermined distance from the edge which is closest to the second display region. Further, the first fringe region may be a divided fringe region and have an edge that is the whole one edge of the first display region 310. The first distance may be determined appropriately for different situations. For example, the distance may be within the range of 10 to 20% of the width of the first display region 310. The first distance may be close to the horizontal length of the pointing region. The first distance is preferably variable. This means that the first fringe region may not be rectangular. The first fringe region may be regarded as a unit region that is a division of a larger fringe region that includes multiple edges. The first fringe region is preferably a unit region adjoining to the second display region 320.

In the example of FIG. 6A, the fringe region 511 is shown as the region enclosed by the lines connecting vertices P1, P2, P6 and P5. The fringe region 511 corresponds to the side 311 of the first display region 310. FIG. 6A shows the fringe region 512 as a region enclosed by the lines connecting vertices P2, P3, P7 and P6. The fringe region 512 corresponds to the side 312 of the first display region 310. FIG. 6A shows the fringe region 513 as a region enclosed by the lines connecting vertices P3, P4, P8 and P7. The fringe region 513 corresponds to the side 313 of the first display region 310. FIG. 6A shows the fringe region 514 as a region enclosed by the lines connecting vertices P4, P1, P5 and P8. The fringe region 514 corresponds to the side 314 of the first display region 310.

When the pointer image 330 is within the first fringe region, that is, within the fringe region 513, the CPU 101 preferably assigns a predetermined second size for the pointing region 500. In FIG. 6A, the fringe region 513 is preferably set in the first display region 310. In FIG. 6A, the pointing region 500 is preferably set as a square whose one side has a length of L2 (L1<L2).

Similarly, as shown in FIG. 6B, four fringe regions 521-524 are preferably set in the second display region 320. Each of the fringe regions 521-524 may also be called a unit region that is a constituent of a fringe region of the second display region 320. The second fringe region may be set within a predetermined distance from the edge of the second display region 320, which is closest to the first display region 310. The second distance may be determined appropriately for different situations. For example, the distance may be within the range of 10 to 20% of the width of the second display region 320. The second distance may be close to the horizontal length of the pointing region 500. The second distance is preferably variable. This means that the second fringe region 521 is preferably not rectangular. The second fringe region 521 may be regarded as a division of a larger fringe region that includes multiple edges. The second fringe region 521 is a unit region adjoining to the first display region 310.

The fringe region 521 is shown enclosed by lines connecting vertices P9, P10, P14 and P13. The fringe region 521 corresponds to the side 321 of the second display region 320. The fringe region 522 is shown enclosed by lines connecting vertices P10, P11, P15 and P14. The fringe region 522 corresponds to the side 322 of the second display region 320. The fringe region 523 is shown enclosed by lines connecting vertices P11, P12, P16 and P15. The fringe region 523 corresponds to the side 323 of the second display region 320. The fringe region 524 is shown enclosed by lines connecting vertices P12, P9, P13 and P16. The fringe region 524 corresponds to the side 324 of the second display region 320.

When the pointer image 330 is within the second fringe region, that is, the fringe region 521, the CPU 101 preferably sets the size of the pointing region 500 into the third size. In FIG. 6B, the pointing region 500 is set as a square whose one side has a length of L3 (L1<L3).

As would be understood by one skilled in the art, the fringe regions 511-514 and 521-524 shown in the examples of FIGS. 5A-B and 6A-B are for illustrative purposes, and it is understood that the shape and size of the fringe regions 511-514 and 521-524 are not limited to the shapes and sizes displayed in FIGS. 5A-B and 6A-B. The shapes and sizes of the fringe regions may be any arbitrary shape and size. L1, L2 and L3 can take any values under the constraint that L1 is less than L2 and L3.

The pointing region 500 of the present embodiment is preferably internally assigned in order to execute the below-described determination process. The CPU 101 preferably does not display the pointing region 500 on the monitor. However, the CPU 101 may display the pointing region 500 by altering the color tone of the area that the pointing region 500 occupies in the virtual space 300. The color tone is generally made up of hue, saturation and brightness. The CPU 101 may display the region occupied by the pointing region 500 by altering one or more out of hue, saturation and brightness.

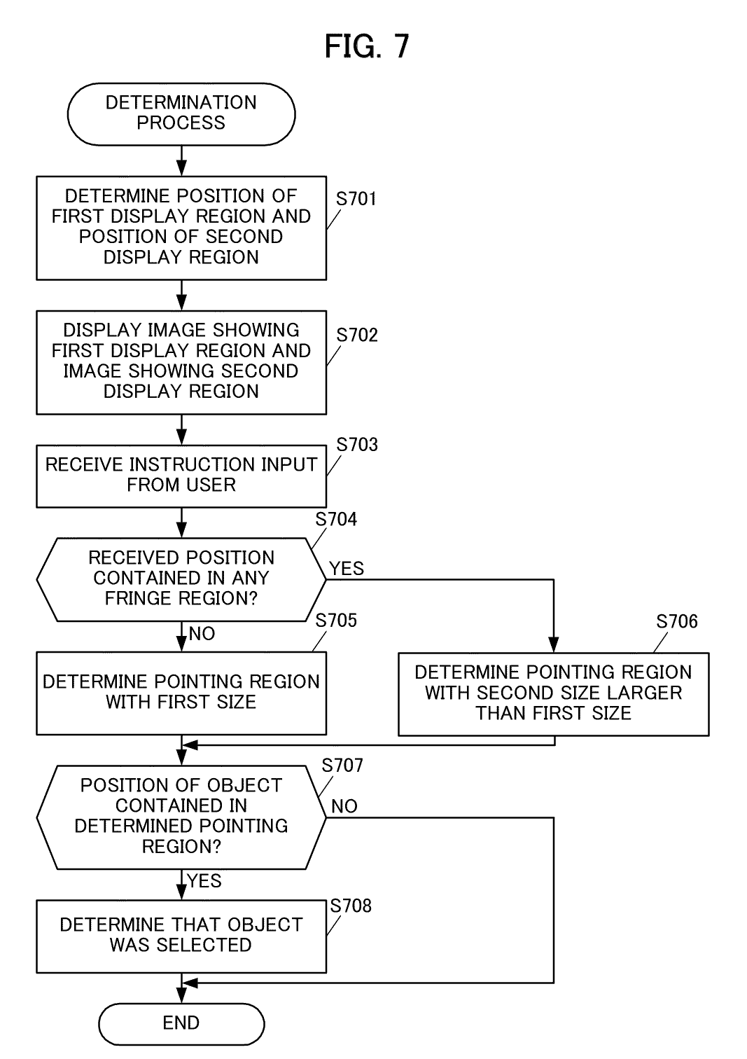

The preferred determination process executed by the various preferred components of the determination apparatus 200 of this preferred embodiment will be described hereinafter with reference to the flowchart in FIG. 7.

First, in step S701 the CPU 101 preferably determines the position of the first display region 310 and the position of the second display region 320 in the virtual space 300. For example, the CPU 101 may receive positioning input from a user operating an input device, which may result in moving the position of the first display region 310 and/or the second display region 320. Whereupon, the CPU 101 preferably moves the position of the first display region 310 and/or the second display region 320 in the virtual space 300.

When the position of the first display region 310 is determined, in step S702, the CPU 101 preferably displays, in the first window (or the first monitor), an image showing the contents of the first display region 310. The image showing the contents of the first display region 310 may be a portion of the image showing the virtual space 300 in its entirety. Similarly, in step S702 when the position of the second display region 320 is determined, the CPU 101 preferably displays, in the second window (or second monitor), an image showing the contents of the second display region 320. The image showing the contents of the second display region 320 may be a portion of the image showing the virtual space 300 in its entirety.

In step S703, the CPU 101 preferably receives instruction input designating a position in virtual space 300 from, for example, a user. This position may be a position in the first display region 310 or in the second display region 320.

By way of example, a user may manipulate the controller 105 and move the position of the pointer image 330. The pointer image 330 may be displayed in the first display region 310 or in the second display region 320. The position indicated by the pointer image 330 is preferably the position designated by the user's instruction input.

As noted in step S703 above, the CPU 101 preferably receives instruction input indicating the position. Next, in step S704, the CPU 101 preferably determines whether this position is in any of the fringe regions, such as, for example, the fringe regions 511-514 of the first display region 310 shown in FIG. 6A, or, for example, the fringe regions 521-524 of the second display region 320

If the position indicated by the instruction input received in step S703 is not in any of the fringe regions (step S704; No), the CPU 101 preferably proceeds to step S705 and preferably determines the pointing region 500 with a first size. The pointing region 500 preferably maintains this position. The fringe regions of the first display region 310 may be 511-514. In addition, the fringe regions of the second display region 320 may be 521-524.

For example, when the position of the pointer image 330 is not in any of the fringe regions, the CPU 101 preferably assigns the pointing region 500 as shown in FIG. 5A. In the example of FIG. 5A, the pointing region 500 is shown as a region enclosing a square of side length L1. The illustrative fringe regions of the first display region 310 of the example in FIG. 5A are shown as 511-514. In addition, the illustrative fringe regions of the second display region 320 of the example in FIG. 5B are shown as 521-524. FIG. 5A shows the centroid of the illustrative pointing region 500 as the position of the pointer image 330.

On the other hand, if the position indicated by the instruction input received in step S703 is determined to be inside one of the fringe regions (step S704; Yes), the CPU 101 preferably proceeds to step S706 and preferably determines the pointing region 500 with a second size larger than the first size. In this case, the pointing region 500 preferably maintains this position. FIG. 5A shows the illustrative fringe regions of the first display region as 511-514. FIG. 5B shows the illustrative fringe regions of the second display region 320 as 521-524.

For example, when the position of the pointer image 330 is in the fringe region 513 as shown in FIG. 6A, the CPU 101 preferably assigns the pointing region 500 as in step S706. In this case, the pointing region 500 may be a square of side length L2 (L1<L2). The centroid of the pointing region 500 may be the position of the pointer image 330. In other words, if the position shown by the pointer image 330 is inside any of the fringe regions, the pointing region 500 is preferably larger. Next, in step S707, the CPU 101 preferably determines whether the position of the object 550 is contained within the pointing region 500 determined in step S706.

If the CPU 101 determines that the position of the object 550 is not contained in the pointing region 500 (step S707; No), the CPU 101 preferably concludes the determination process.

If the CPU 101 determines that the position of the object 550 is contained in the pointing region 500 (step S707; Yes), the CPU 101 preferably proceeds to step S708 where the CPU 101 preferably determines that the object 550 has been selected by the user.

By way of example, the CPU 101 may execute a game in which a player “captures” the object 550 in the virtual space. The object 550 may move randomly in the virtual space. The player may “capture” the object 550 by matching the pointer image 330 with the position of the object 550. The CPU 101 may advance the game in accordance with input from the user. Upon determining that the position of the object 550 is contained in the pointing region 500, the CPU 101 preferably acknowledges that the object 550 has been “captured” by the player. Furthermore, the CPU 101 may add predetermined points to the player's score.

The pointing region 500 of the present embodiment preferably becomes larger when the position of pointer image 330 is in any of the fringe regions. Accordingly, the position of the object 550 more readily falls inside the pointing region 500. As a result, a user may easily designate positions in areas close to the boundaries of the first display region 310 or the second display region 320.

Referring to the working example shown in FIG. 6A, the object 550B is shown positioned in a corner of the first display region 310. Only a portion of the object 550B is shown displayed in the first display region 310. Accordingly, it is relatively difficult for a user to point to the object 550B with one operation. In addition, suppose the object 550B moves between a position in the first display region 310 and a position in the second display region 320. The user must determine which display region to indicate while instantaneously comparing the two display regions. As a result, it is difficult for the user to point to 550B with a single operation. For this reason, video games could become extremely difficult near the fringe regions of the display regions, i.e. the corners of the screen.

However, the pointing region 500 of this preferred embodiment preferably becomes wider near the fringe regions making it easier for a user to hit the object 550 with the pointer image 330. When the pointing region 500 does not enlarge, a user may have difficulty designating positions near the fringe regions. However, in the present embodiment, the determination apparatus 200 loosen collision detection. It is possible to adjust the difficulty level of the game. The determination apparatus 200 makes it easier for a user to designate positions in the corners of the displayed screen.

In addition, the CPU 101 may correlate the width of the pointing region 500 in the fringe regions with the player's skill level. For example, if the CPU 101 determines a player to be a novice, the CPU 101 may enlarge the pointing region 500 in the fringe regions. In other words, when a player is deemed a novice, the pointing region 500 may be enlarged when the position of the pointer image 330 enters the fringe regions. On the other hand, if the CPU 101 determines a player to be advanced, the CPU 101 may leave set values unchanged without enlarging the pointing region 500 in the fringe regions. In other words, when a player is deemed to be advanced, the pointing region 500 may not be enlarged even when the position of the pointer image 330 enters the fringe regions. For novice players not yet accustomed to the game, the function to assist novices may be built into a game. The CPU 101 may also determine the skill level of the player in accordance with selection entered by a player. In other words, the CPU 101 determines whether the player is a novice.

The CPU 101 may also store data relating to the history of the game on the external memory 106 or the like. The CPU 101 may appropriately update this data and estimate whether the user's skill level is above a predetermined level based on such stored data. Data showing the game's history may be, for example, the number of times a user plays the game, the time a user generally plays the game, the time slot a user plays the game, the playing frequency, etc.

In addition, when, for example, the date (i.e., the current time and current date) that the player plays the game is in a predetermined time slot (e.g., nighttime, etc.), the CPU 101 may enlarge the pointing region 500 in the fringe regions. In other words, during this time slot the CPU 101 may enlarge the pointing region 500 when the position of the pointer image 330 enters the fringe regions. In this manner, if it is estimated that the player will have difficulty viewing the screen at a certain time slot due to darkness, indication of the screen's corners is made easier. As a result, game advancement is made easier for a player.

A second preferred embodiment will be described hereinafter. In this embodiment, there is preferably a plurality of fringe regions. A change in the shape and size of the pointing region 500 is preferably triggered when the pointer image 330 enters the fringe regions.

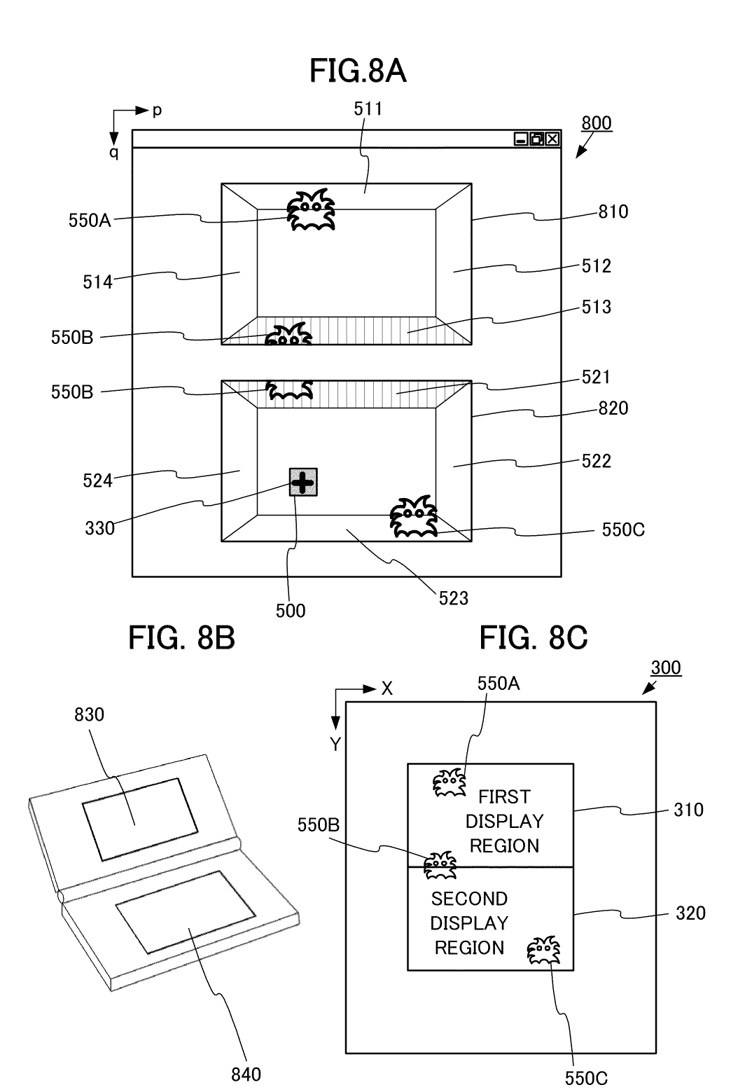

FIG. 8A is a drawing showing an example of the composition of the screen 800. FIG. 8B is a drawing showing an example of the arrangement of the displays 830 and 840. FIG. 8C is a drawing showing the first display region 310 and the second display region 320 set in the virtual space 300. In this embodiment, the first display region 310 and the second display region 320 may neighbor each other, as shown in FIG. 8C. In this case, a predetermined side of the first display region 310 and a predetermined side of the second display region 320 may overlap each other.

FIG. 8A shows the screen 800 displayed on the monitor. An image showing the first display region 310 is preferably output to the first window 810. An image showing the second display region 320 is preferably output to the second window 820. The first window 810 and the second window 820 are preferably positioned neighboring each other so that the positional relationship between the first display region 310 and the second display region 320 in the virtual space 300 is preserved.

Alternatively, FIG. 8B shows an example of a plurality of displays. An image showing the first display region 310 may be displayed on the first display 830. An image showing the second display region 320 may be displayed on the second display 840. The first display 830 and the second display 840 may be positioned neighboring each other so that the positional relationship between the first display region 310 and the second display region 320 in the virtual space 300 is preserved.

The first window 810 and the second window 820 may abut each other, or may be separated. The first display 830 and the second display 840 may also abut each other or may be separated. For example, the first display region 310 may be positioned above the second display region 320 in the virtual space 300 in FIG. 8C. In other words, the first display region 310 may be positioned on the side with smaller Y coordinates than the second display region 320. In addition, from a player's perspective, the image showing the first display region 310 is positioned on top and the image showing the second display region 320 is positioned on bottom, as shown in FIG. 8A. In other words, the first window 810 is positioned on the top while the second window 820 is positioned on the bottom.

In the example of FIG. 8A, the origin of the local coordinate system (the p-q coordinate system in FIG. 8A) may be the upper left corner of the screen 800. This local coordinate system is preferably defined in the screen 800. From a player's perspective, the first display region 310 is positioned above the second display region 320, as shown in FIG. 8C. In addition, the global coordinate system (i.e., the X-Y coordinate system) is preferably defined in the virtual space 300. In this global coordinate system, the Y coordinate value of an arbitrary point in the first display region 310 is preferably smaller than the Y coordinate value of an arbitrary point in the second display region 320.

From a player's perspective, the first display region 310 is positioned above the second display region 320. As noted above, the local coordinate system (i.e., the p-q coordinate system) is preferably defined in the screen 800. In this local coordinate system, the q coordinate value of an arbitrary point in the first display region 310 is preferably smaller than the q coordinate value of an arbitrary point in the second display region 320.

The fringe region 513 of the first display region 310 and the fringe region 521 of the second display region 320 are preferably displayed neighboring each other.

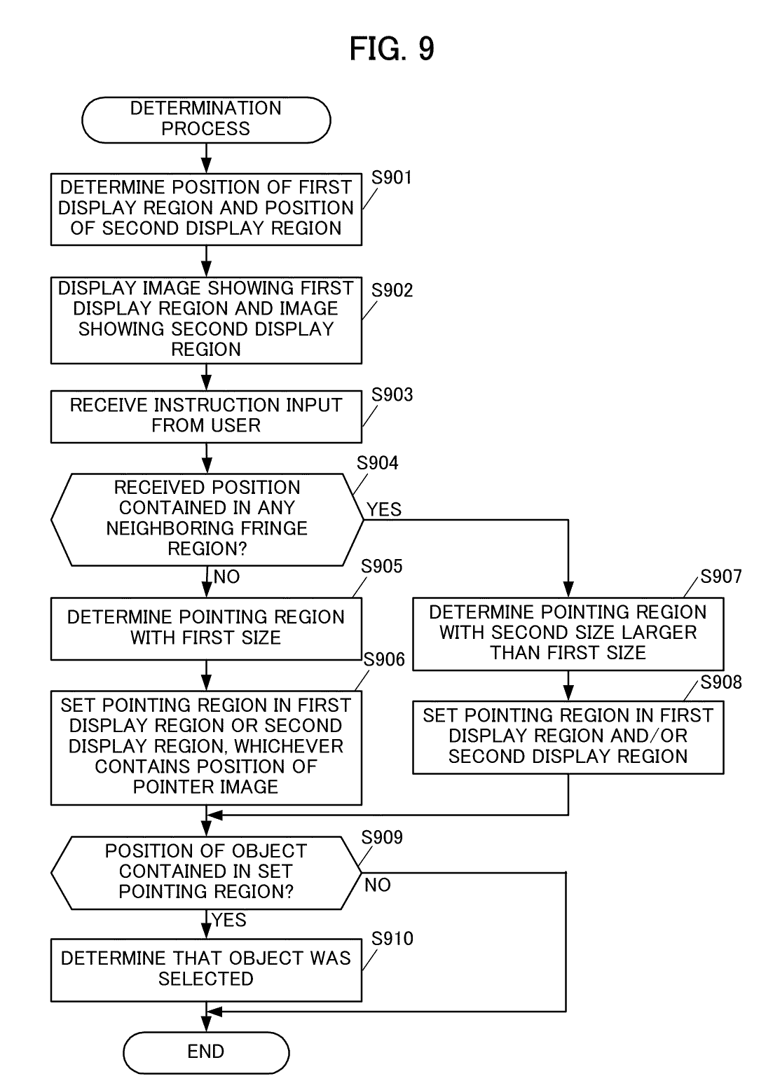

The determination process of this embodiment is described hereinafter with reference to the flowchart in FIG. 9.

First, in step S901, the CPU 101 preferably determines the position of the first display region 310 and the position of the second display region 320 in the virtual space 300.

In step S902, upon determining the position of the first display region 310, the CPU 101 preferably displays the image showing the contents of the first display region 310 in the first window 810. The first display region 310 is contained in the virtual space 300. Also in step S902, upon determining the position of the second display region 320, the CPU 101 preferably displays the image showing the contents of the second display region 320 in the second window 820. In step S902, the second display region 320 is contained in the virtual space 300.

In step S903, the CPU 101 may receive instruction input from, for example, a user. This instruction input may designate an arbitrary position in the first display region 310 or designates an arbitrary position in the second display region 320. Upon receiving instruction input in step S903, the CPU 101 preferably determines whether the received position is contained in any of the fringe regions neighboring the other display region in step S904. In other words, the CPU 101 preferably determines whether the position indicated by this instruction input is in the fringe region 513 of the first display region 310 or the fringe region 521 of the second display region 320. If it is determined that the received position is not contained in either of the fringe regions neighboring the other display region (step S904; No), the CPU 101 preferably determines the pointing region 500 with a predetermined first size in step S905. Furthermore, the CPU 101 preferably sets the pointing region 500 with a predetermined first size. The CPU 101 preferably sets the pointing region 500 in the display region containing the pointer image 330 in step S906. In other words, when the pointer image 330 is in the first display region 310, the CPU 101 preferably sets the pointing region 500 in the first display region 310. In addition, when the pointer image 300 is in the second display region 320, the CPU 101 preferably sets the pointing region 500 in the second display region 320.

On the other hand, if it is determined that the received position is contained in either of the fringe regions that neighbor the other display region (step S904; Yes), the CPU 101 preferably determines the pointing region 500 with a predetermined second size in step S907. The second size may be larger than the first size.

Furthermore, the CPU 101 preferably sets the pointing region 500 with the second size in the first display region 310 and/or the second display region 320 in step S908.

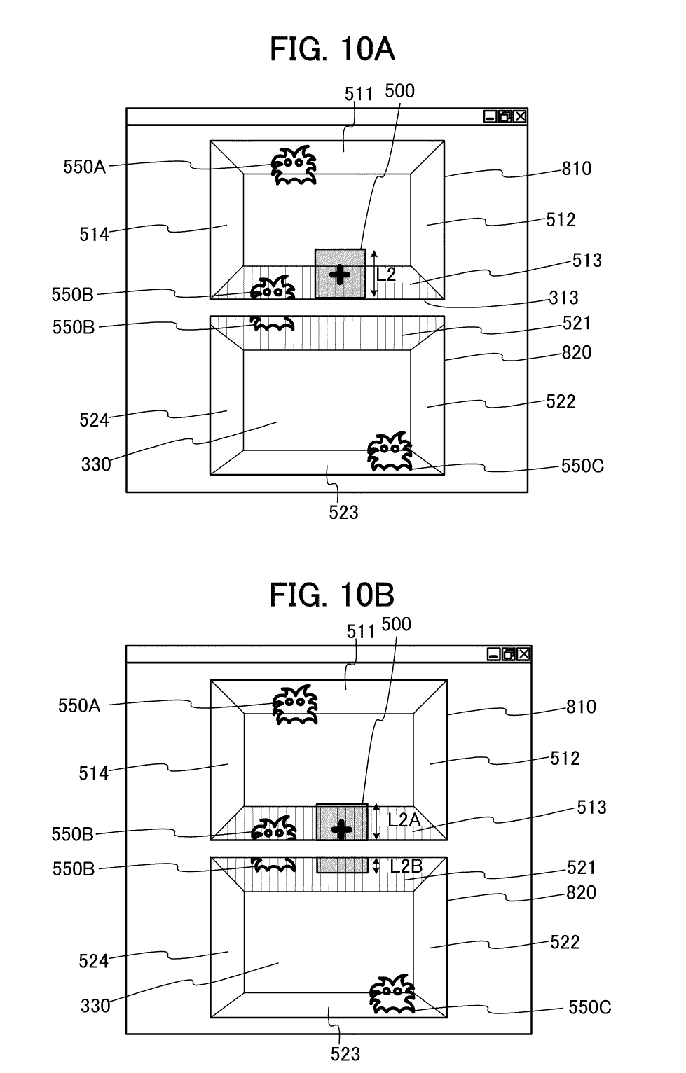

The CPU 101 decides to set the pointing region 500 in the first display region 310 “or” the second display region 320 when either of the following conditions is satisfied: the pointing region 500 as a whole is contained in the first display region 310 as shown in FIG. 10A; or, the pointing region 500 as a whole is contained in the second display region 320.

By way of example, suppose the pointing region 500 is set in the shape of a square. The side length of this illustrative square may be L2. In addition, the centroid position of this square may be the position of the pointer image 330. If the distance between the side 313 of the first display region 310 and the pointer image 330 is more than L2/2 (half of the length L2), the CPU 101 will preferably establish the pointing region 500 as a whole in the first display region 310. The circumstance in which the CPU 101 assigns a pointing region 500 in the second display region 320 is preferably the same as the circumstances of the first display region 310.

The CPU 101 determines to set the pointing region 500 in the first display region 310 “and” the second display region 320 when either of the following conditions is satisfied: the position of the pointer image 330 is in the first display region 310 and the pointing region 500 as a whole is not completely contained within the first display region 310 but is also contained in the second display region 320, as shown in FIG. 10B; or the position of the pointer image 330 is in the second display region 320 and the pointing region 500 as a whole is not completely contained within the second display region 320 but is also contained in the first display region 310.

By way of example, suppose the pointing region 500 is set in the shape of a square. The side length of this illustrative square may be L2. In addition, the centroid position of this square may be the position of the pointer image 330. If the distance between the side 313 of the first display region 310 and the pointer image 330 is less than L2/2 (half of the length L2), the whole pointing region 500 is not contained in the first display region 310. At this time, only a portion of the pointing region 500 may be contained in the first display region 310. The part contained therein may be a portion of length L2A from the top of the pointing region 500, as shown in FIG. 10B.

When the pointing region 500 as a whole is not contained in the first display region 310, the CPU 101 may position the non-contained portion in the second display region 320. In other words, the CPU 101 may position a portion of the pointing region 500 in the second display region 320. As shown in FIG. 10B, this portion may be a portion of length L2B from the bottom of the pointing region 500, where L2A+L2B=L2. The CPU 101 may enlarge the pointing region 500 so that L2A+L2B>L2. In other words, CPU 101 may expand the pointing region 500 in the direction of the neighboring fringe region to a user viewing the screen 800.

Next, in step S909 the CPU 101 preferably determines whether the position of an object 550 is contained in the pointing region 500 set in steps S906 or S908. If it is determined in step S909 that the position of the object 550 is not contained in the pointing region 500 (step S909; No), the CPU 101 preferably concludes the determination process. If it is determined that the position of the object 550 is contained in the pointing region 500 (step S909; Yes), the CPU 101 preferably determines, in step S910, that the object 550 was selected by the user.

In this embodiment, when the position of the pointer image 330 is contained in either of the fringe regions neighboring the other display region, the CPU 101 enlarges the pointing region 500. As a result, the position of the object 550 easily falls in the pointing region 500 making it easier for a user to designate the position in the portion of the display region that is close to the other display region. In other words, designating the position in a portion of the first display region 310 that is close to the second display region 320 becomes easier. In addition, designating the position in a portion of the second display region 320 that is close to the first display region 310 becomes easier.

By way of example, assume the object 550B shown in FIG. 8A is positioned at the corner of the first display region 310. Only a portion of the object 550B is displayed in the first display region 310, which makes pointing to the object 550B with one operation difficult for a user. In addition, if there is a “gap” between the first window 810 and the second window 820, this gap could be erroneously pointed to by the user, which also makes pointing to the object 550B with one operation difficult for a user. It is desirable that the games not become extremely difficult near the fringe regions or the corners of the screen, contrary to the intentions of a game's creator.

In this preferred embodiment, a fringe region from among the plurality of fringe regions may neighbor another display region. In the present preferred embodiment, the CPU 101 enlarges the pointing region 500 near a neighboring fringe region making hitting the object 550 with the pointer image 330 easier. Without enlarging the pointing region 500, a user may have difficulty designating positions near the neighboring fringe region. However, in the present embodiment, the determination apparatus 200 loosens collision detection. As a result, it is possible to adjust the difficulty of the game. The user can easily designate positions in the corners of the displayed screen.

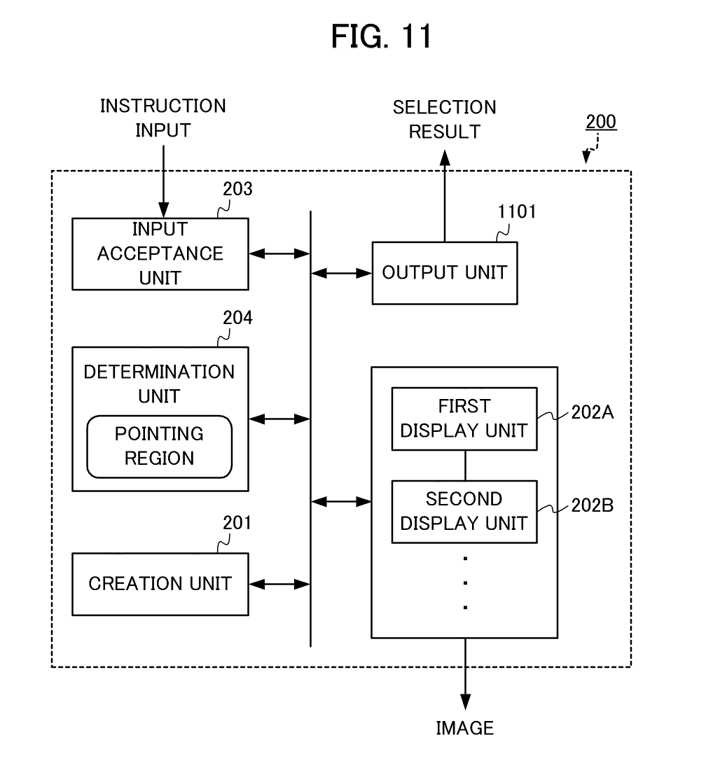

A third preferred embodiment will be described hereinafter. FIG. 11 is a drawing showing the preferred elements of the determination apparatus 200 of this preferred embodiment.

The determination apparatus 200 preferably includes an output unit 1101. The output unit 1101 preferably outputs selection results data identifying an object 550 that overlap with the pointing region 500. In other words, when the position of the object 550 is contained in the pointing region 500, the output unit 1101 preferably outputs this selection result. The CPU 101 working in conjunction with the image processor 108, preferably functions as the output unit 1101.

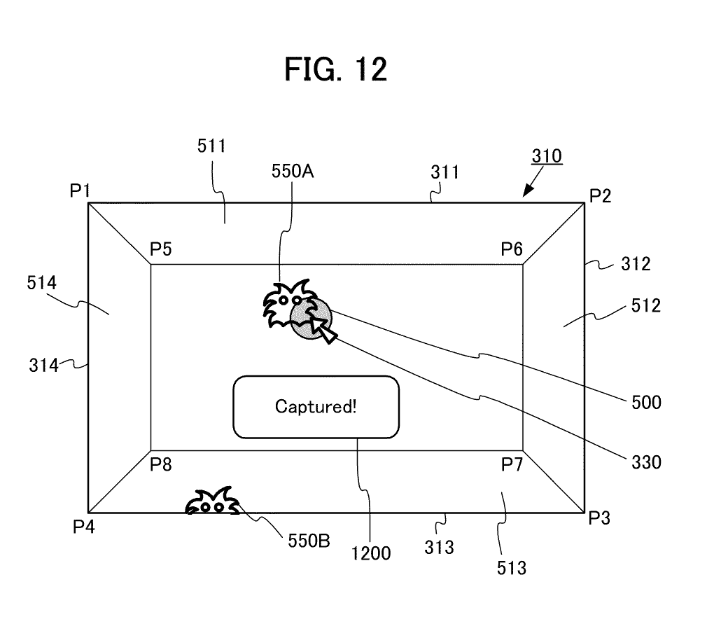

Data identifying the object 550 may be, for example, a message 1200 indicating that the object 500 has been selected by the user as shown in the example of FIG. 12. Alternatively, data indicating the object 550 may be image data showing the object 550 was selected by the user.

In addition, when the object 550 and the pointing region 500 overlap, the CPU 101 may play predetermined audio data by controlling the audio processor 109. In this case, the selection results are output through reproduction of the audio data. The output contents is preferably data indicating that the object 550 has been selected. When the CPU 101 plays the audio data, the CPU 101 may concurrently display a message 1200 by controlling the image processor 108. In addition, the CPU 101 may also reproduce audio data in place of displaying the message 1200. For example, the CPU 101 may output data indicating that the object 550 has been selected after determinations in the above-described step S708 or step S910 have been made. In step S708 or step S910, the CPU 101 preferably determines that the object 550 has been selected by the user.

The output contents are data indicating that the object 550 has been selected. The CPU 101 may output the selection results when the following two conditions are satisfied: the position of an object 550 is contained in the pointing region 500; and a predetermined input operation is performed. The predetermined input operation may be, for example, a mouse click operation, a double click operation, the operation of pressing a predetermined button, etc.

With this embodiment, a user can accurately grasp whether they were able to designate the position of the object 550. In other words, it becomes clear whether the position of the object 550 is contained in the pointing region 500. The user can easily identify the set location of the pointing region 500 at that time.

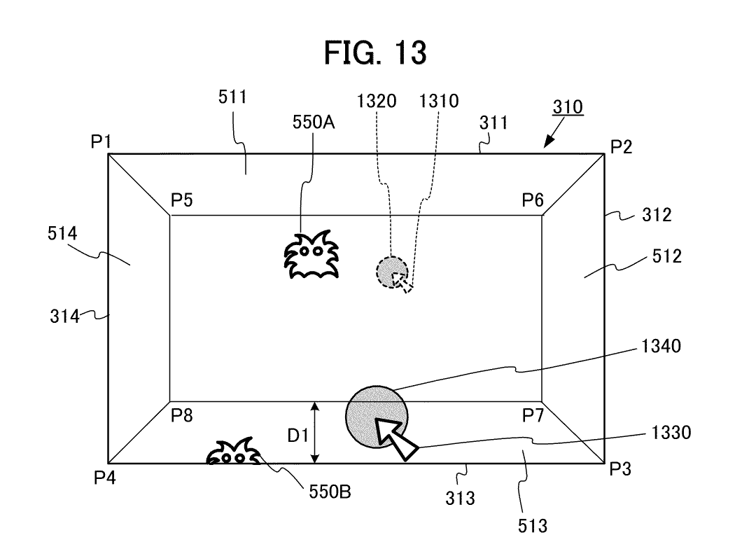

A fourth preferred embodiment will be described hereinafter. In this embodiment, the display shape of the pointer image 330 is preferably altered based on whether the position of the pointer image 330 is in a fringe region. FIG. 13 is a drawing showing an example of an image exhibiting the first display region 310.

The illustrative fringe regions 511, 512, 513 and 514 are shown in the first display region 310. When the position designated by the user is not contained in any of the fringe regions, the CPU 101 preferably displays a pointer image 1310 with a predetermined size. On the other hand, when the position designated by the user is contained in any of the fringe regions, the CPU 101 preferably displays the pointer image 1330. The size of the pointer image 1310 is enlarged by a predetermined value to realize the pointer image 1330.

In addition, when the position designated by the user is not contained in any of the fringe regions, the CPU 101 preferably sets a pointing region 1320 with a first size. On the other hand, when the position designated by the user is contained in any of the fringe regions, the CPU 101 preferably sets a pointing region 1340 with a second size. As discussed above, the second size may be larger than the first size.

In FIG. 13, two pointer images 1310 and 1330 are shown for illustrative purposes in contrasting sizes, but only one of the pointer images is preferably displayed on the monitor. Similarly, the two illustrative pointing regions 1320 and 1340 are displayed in FIG. 13. However, only one of the pointing regions is set in the virtual space 300. In addition, data indicating the position and shape of the pointing regions 1320 and 1340 need not be displayed on the monitor.

When the position designated by the user is contained in any of the fringe regions, the CPU 101 may enlarge pointer image 330 as the distance D between the designated position and the side containing the fringe region becomes smaller. In other words, the shorter the distance between that side and the position of the pointer image 1330, the larger pointer image 1330 will be.

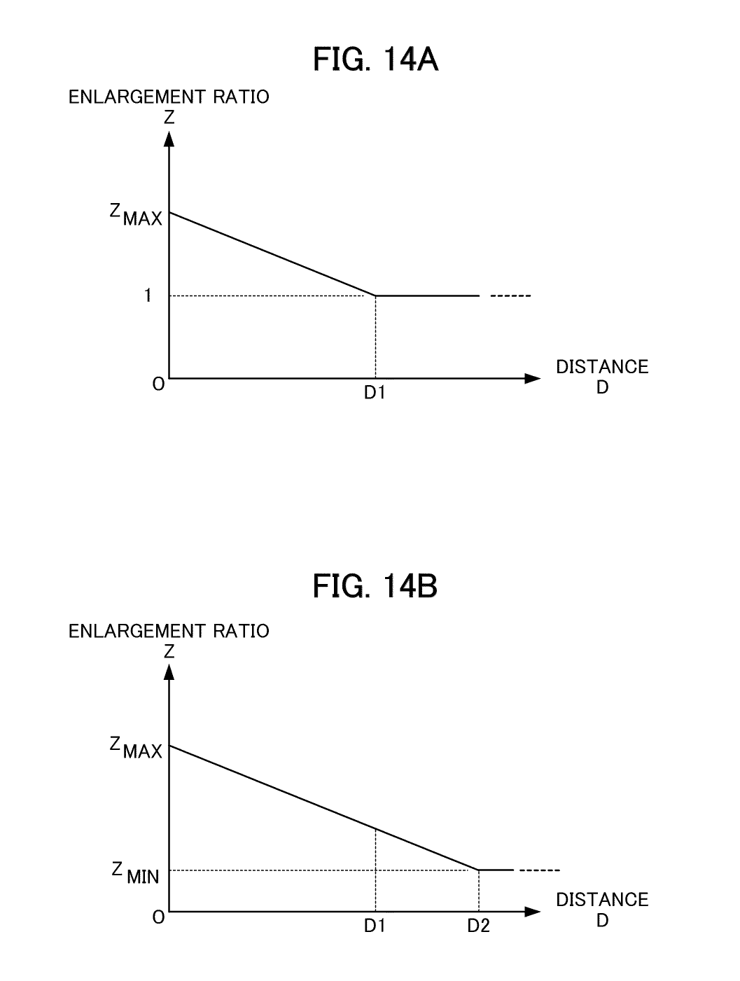

By way of example, suppose the height of the fringe region 513 is D1, as shown in FIG. 13. As shown in FIG. 14A, the CPU 101 may monotonically decrease the enlargement ratio Z of the display size of the pointer image 1330 with respect to the distance D with 0≦D≦D1. The enlargement ratio varies in the range of 1≦Z≦ZMAX. On the other hand, when D>D1, the CPU 101 may display the pointer image 1310 whose size is a predetermined value (e.g., the enlargement ratio Z=1). Accordingly, the closer the user-designated position is to the “edge” of the first display region 310, the larger the pointer image 1330 becomes. As a result, the user can easily perceive the currently designated position

Alternatively, the enlargement ratio Z of the display size of the pointer image 1330 may be monotonically decreased with respect to the distance D, as shown in FIG. 14B. In this scenario, there is no relationship between the enlargement ratio Z and the height of the fringe region 513. The enlargement ratio varies in the range of ZMIN≦Z≦ZMAX. The CPU 101 preferably makes the enlargement ratio constant when D≧D2 (where D2 is a predetermined value). The value of D2 may be larger than zero and less than the distance between the center point of the first display region 310 and the side 313 containing the fringe region 513.

A description has been provided here using the fringe region 513 of the first display region 310 as an example. However, the CPU 101 may similarly change the size of the pointer image 1330 when they are positioned in other fringe regions such as, for example, fringe regions 511, 512 and 514 of the first display region 310, and similarly in the fringe regions 521-524 of the second display region 320. Furthermore, the CPU 101 may change the color tone and the flashing speed of the pointer images 1330.

For example, the CPU 101 may increase the brightness of the pointer image 1330 as the distance D diminishes. In other words, the closer the position designated by the user is to the “edge” of the display region, the brighter the pointer images 1330 becomes. Accordingly, highlighting of the pointer images 1330 occurs in the fringe region. As a result, the user can easily designate the position by moving the pointer images 1330. Consequently, designation in the fringe region or the corners of the screen becomes easier. The CPU 101 may change any combination of hue, saturation or brightness of pointer image 1330.

As noted above, there are also fringe regions neighboring the second display region 320 among the fringe regions of the first display region 310. When the position designated by the user is in any of these neighboring fringe regions, the CPU 101 may change the display shape of the pointer image 1330.

With this embodiment, the user can perceive simply and accurately data relating to the position designated. This data may be data regarding whether the designated position is contained within the fringe region, or this data may be data regarding the proximity distance between the designated position and the boundary of the display region. This allows the user to designate positions close to the boundary of the display region easily.

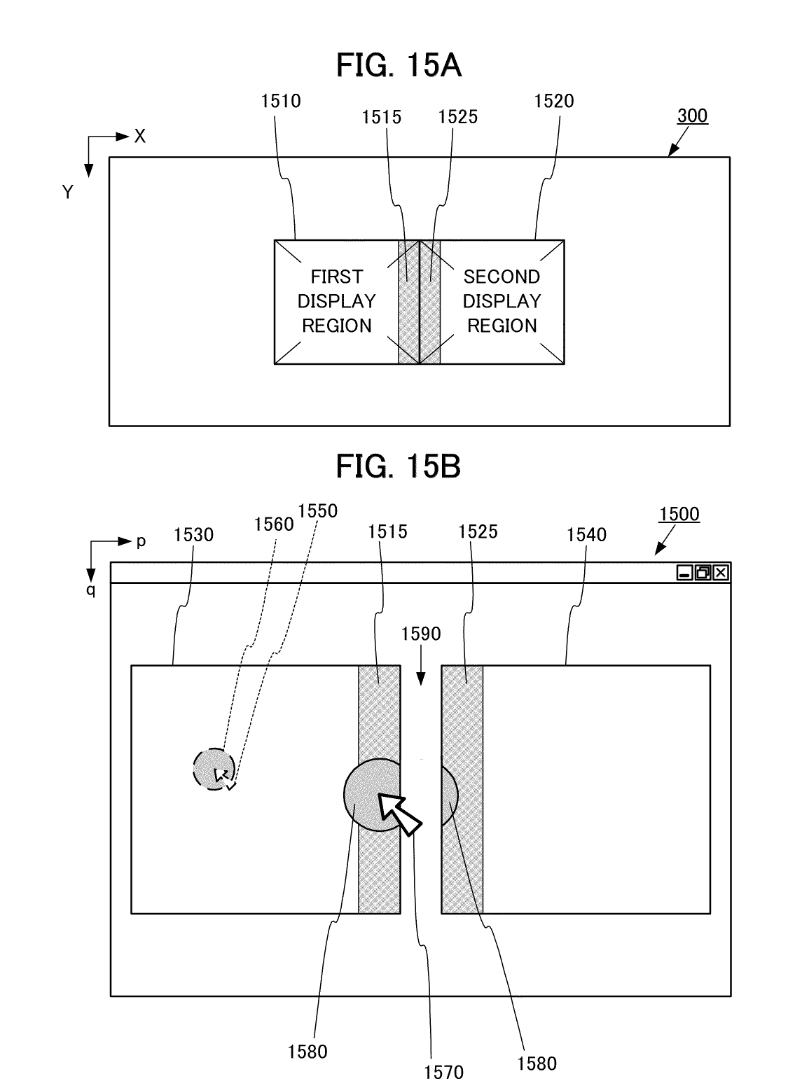

A fifth preferred embodiment will be described hereinafter. FIG. 15A is a drawing showing a preferred first display region 1510 and a preferred second display region 1520 according to this embodiment. In the previously described preferred embodiments, the first display region 310 and the second display region 320 preferably neighbor each other in the Y direction. However, the first display region 1510 and the second display region 1520 of this fifth preferred embodiment preferably neighbor each other in the X direction.

FIG. 15B is a drawing showing an illustrative screen 1500 displayed on the monitor. The screen 1500 preferably contains a first window 1530 and a second window 1540. The first window 1530 displays an image inside the first display region 1510 of FIG. 15A. The second window 1540 displays the image inside the second display region 1520.

One fringe region 1515 is preferably defined inside the first display region 1510. One fringe region 1525 is preferably defined inside the second display region 1520. The fringe region 1515 and the fringe region 1525 preferably neighbor each other in the screen 1500. As shown in FIG. 15B, a sole fringe region may correspond to a single display region.

A gap 1590 with a predetermined width preferably separates the first window 1530 and the second window 1540. The size of the predetermined width is arbitrary. For example, if the size of the predetermined value were made zero, the first window 1530 and the second window 1540 would abut each other.

In the above-described embodiments, the CPU 101 preferably positions the pointer image 330 inside the virtual space 300. However, in the present embodiment, the CPU 101 preferably positions the pointer images 1550 and 1570 in the screen 1500. In other words, the pointer images 1550 and 1570 may be displayed without being contained in the first window 1530 or the second window 1540, as shown in FIG. 15B.

In FIG. 15B, the two pointer images 1550 and 1570 are displayed for illustrative purposes in contrasting sizes. However, only one of the pointer images is preferably displayed on the screen 1500. When the position indicated by the user is not contained in the fringe regions 1515 and 1525, the CPU 101 preferably positions a pointer image 1550 with a predetermined size at the indicated position. Furthermore, the CPU 101 preferably sets a pointing region 1560 contained in the virtual space 300.

In addition, when the position indicated by the user is contained in either of the fringe regions 1515 or 1525, the CPU 101 preferably positions a pointer image 1570 that is larger in size than the predetermined value at the indicated position. The CPU 101 may use as the pointer image 1570 the pointer image 1550 enlarged by an arbitrary enlargement ratio.

Furthermore, the CPU 101 preferably sets a pointing region 1580 in the virtual space 300 containing the position indicated by the user. The area of the pointing region 1580 is preferably larger than the area of the pointing region 1560.

The CPU 101 may set as the pointer image 1570 an image created by executing an arbitrary image conversion process on the pointer image 1550. Specifically, this process may be enlarging or contracting the pointer image 1570 in a predetermined direction, or rotating it by a predetermined angle, changing the color tone (i.e., hue, saturation or brightness), etc.

A sixth preferred embodiment will be described hereinafter. In the above-described embodiments, the size of the pointing region 500 is altered based on the position indicated by the user. However, in the present embodiment, the shape instead of the size, or in addition to the size, is adjusted based on the position indicated by the user. The characteristics are described hereinafter as a variation of the above-described fifth embodiment.

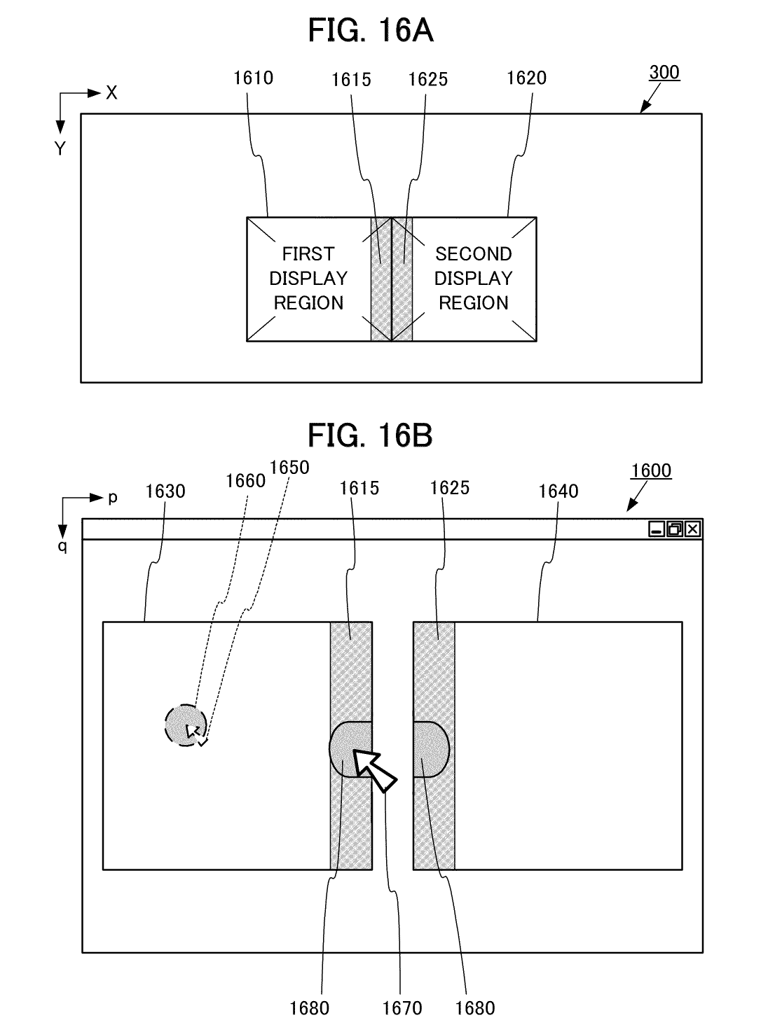

FIG. 16A is a drawing showing a preferred first display region 1610 and a preferred second display region 1620 according to this embodiment. In FIG. 16A, the first display region 1610 and the second display region 1620 preferably neighbor each other in the X direction. FIG. 16B is a drawing showing an illustrative screen 1600 displayed on the monitor. The screen 1600 contains a first window 1630 and a second window 1640. The first window 1630 may display the image inside the first display region 1610. The second window 1640 may display the image inside the second display region 1620.

When the position indicated by the user is not in the fringe regions 1615 and 1625, the CPU 101 preferably sets the pointing region 1660 in the virtual space 300. The pointing region 1660 has a first shape and preferably contains the indicated position.

On the other hand, if the position indicated by the user is contained in either of the fringe regions 1615 and 1625, the CPU 101 preferably positions a pointing region 1680 having a second shape and contains the designated position. The CPU 101 preferably changes the shape of the pointing region 1680. The CPU 101 preferably deforms and enlarges the pointing region 1680 toward the neighboring display region side.

When the position indicated by the user is not in the fringe regions 1615 and 1625, the CPU 101 preferably displays a pointer image 1650 with a predetermined size at the indicated position. In addition, the CPU 101 preferably sets the pointing region 1660 having a first shape. On the other hand, when the position indicated by the user is in the fringe region 1615 or 1625, the CPU 101 preferably expands the size of the pointer image 1660 at the indicated position to realize the pointer image 1670. In addition, the CPU 101 preferably sets a pointing region 1680 having a second shape. The CPU 101 preferably deforms and enlarges pointing region 1680 toward the second display region 1620. The position indicated by the user and the center position of the pointing region 1680 need not coincide.

Referring to the example in FIG. 16B, the pointing region 1680 is shown enlarged even inside the second display region 1620. In other words, the position of the pointing region 1680 is not limited to the inside of the first display region 1610 containing the position indicated by the user. Therefore, when the user wants to designate a position near the fringe region 1625 of the second display region 1620, it is not necessary to move the pointer image 1670 to the second window 1640. The user can designate a position near the fringe region 1625 of the second display region 1620 by inputting instructions indicating a position inside the fringe region 1615 of the first display region 1610. Similarly, even when the position indicated by the user is inside the second display region 1620, the CPU 101 preferably enlarges the pointing region 1680 even within the neighboring first display region 1610. In other words, the pointing region 1680 is not limited to the inside of the second display region 1620 containing the position indicated by the user. Accordingly, a user would not need to move the pointer image 1670 inside the first window 1630, if the user chooses to designate a position in the fringe region 1615 of the first display region 1610. The user may designate a position in the fringe region 1615 of the first display region 1610 by inputting instructions that indicate a position inside the fringe region 1625 of the second display region 1620.

This embodiment allows a user to designate a position near the boundaries of the displayed screen easily, in particular positions in the corners of neighboring display regions.

A seventh preferred embodiment will be described hereinafter. In the following embodiment, a single display monitor preferably corresponds to a single display region.

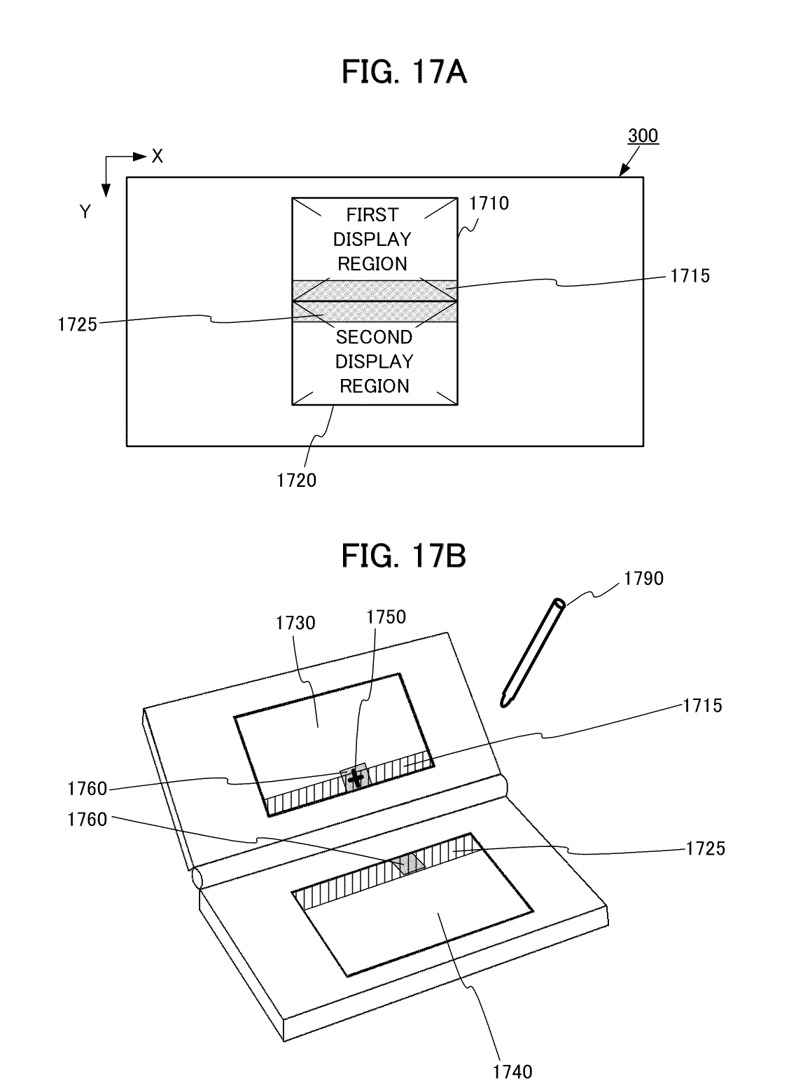

FIG. 17A is a drawing showing a preferred first display region 1710 and a preferred second display region 1720. The first display region 1710 and the second display region 1720 preferably neighbor one another in the Y direction. FIG. 17B is a drawing showing an illustrative arrangement of the first display 1730 and the second display 1740. An image showing the contents of the first display region 1710 may be output to the first display 1730. An image showing the contents of the second display region 1720 may be output to the second display 1740. The first display 1730 and the second display 1740 preferably neighbor one another in order to maintain a positional relationship between the first display region 1710 and the second display region 1720 in the virtual space 300. The fringe region 1715 and the fringe region 1725 preferably neighbor each other in the virtual space 300. Fringe region 1715 and the fringe region 1725 also preferably neighbor each other in real space.

Touch panels may be disposed on the surface of the first display 1730 and the second display 1740. Images, icons, buttons, and the like are preferably displayed on the first display 1730 and the second display 1740. The user may use the touch pen 1790 to contact the touch panel and interact with the images, icons, or buttons that are positioned on the touch panel. The user may input various instructions into the determination apparatus 200 by contacting the touch panel with the touch pen 1790.

As noted above, images, icons, buttons and the like may be displayed in the first display 1730 and the second display 1740. The user may contact the area in the touch panel with the touch pen 1790 to interact with the images, icons, buttons, and the like positioned on the touch panel. In the description below, contacting the corresponding portions of the touch panel with a finger, the touch pen 1790, etc. will be referred to as “touches the (image, icon, button, etc).”

By touching the surface of the first display 1730, a user may designate an arbitrary position in the first display region 1710 within the virtual space 300. Similarly, by touching the surface of the second display 1740, the user may designate an arbitrary position in the second display region 1720 within the virtual space 300.

If a user contacts the touch panel using the touch pen 1790, the CPU 101 preferably displays the pointer image 1750 at the point of contact. Furthermore, the CPU 101 sets a pointing region 1760 containing the touched position. If the touched position (indicated position) by the user is not in the fringe regions 1715 and 1725, the CPU 101 preferably establishes the pointing region 1760 in the virtual space 300. The pointing region 1760 preferably has a first shape and/or first size and preferably contains the position indicated by the user. However, if the position indicated by the user is in either of the fringe regions 1715 and 1725, the CPU 101 preferably sets, in the virtual space 300, the pointing region 1760 with a second shape and/or second size. In this scenario, the pointing region 1760 preferably contains the position indicated by the user.

The CPU 101 may deform and expand the pointing region 1760 in the direction of the neighboring display region. For example, in FIG. 17B the pointing region 1760 is shown expanded into the second display region 1720. Therefore, the pointing region 1760 is not limited to within the first display region 1710 containing the position indicated by the user. Accordingly, a user would not need to move the touch pen 1790 over the second display 1740, if the user chooses to designate a position in the fringe region 1725 of the second display region 1720. A user can designate positions in the fringe region 1725 of the second display region 1720 by touching the position in the fringe region 1715 of the first display region 1710 using, for example, the touch pen 1790.

Similarly, even when the position indicated by the user is in the second display region 1720, the pointing region 1760 can be enlarged into the neighboring first display region 1710. In other words, the pointing region 1760 is not limited to just inside the second display region 1720 containing the position indicated by the user. Accordingly, when the user wants to designate a position near the fringe region 1715 of the first display region 1710, it is not necessary to move the touch pen 1790 over the first display 1730. The user can designate a position in the fringe region 1715 of the first display region 1710 by inputting instructions indicating a position inside the fringe region 1725 of the second display region 1720.

The current preferred embodiment allows a user to easily designate positions near the boundary of the display screen, in particular positions in the corners of the neighboring display region.

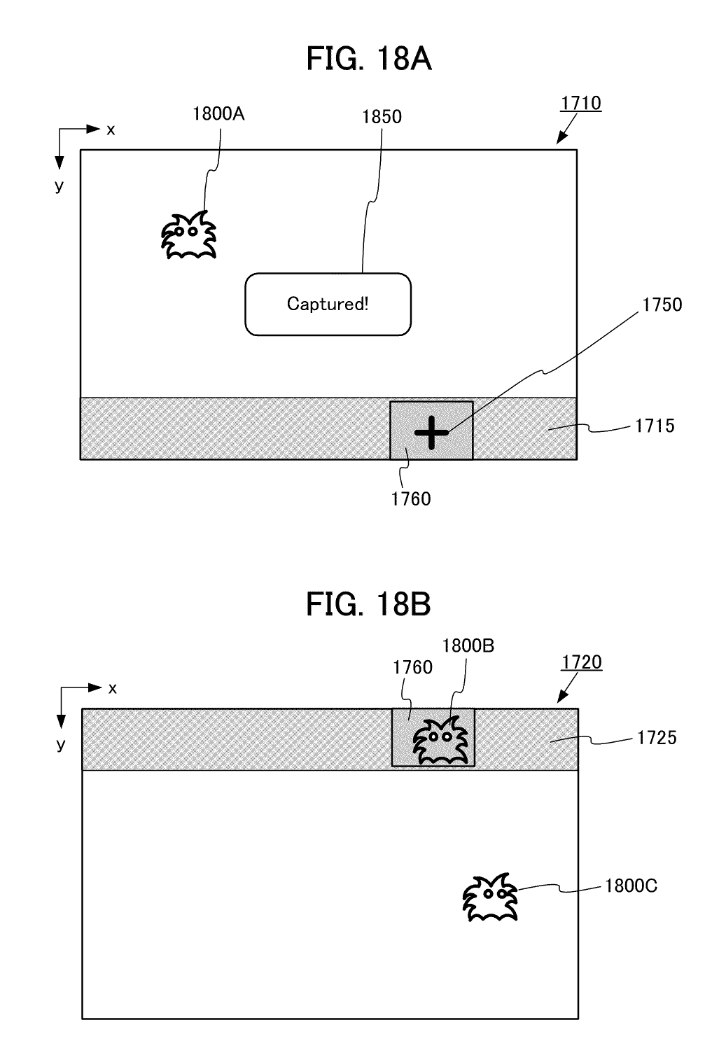

For example, FIGS. 18A and 18B are drawings illustrating a game in which the user touches and captures an object 1800 using the touch pen 1790. The object 1800 move in the virtual space 300.

FIGS. 18A-B show three illustrative objects 1800A-C. By way of example, assume the object 1800B frequently moves back and forth between the fringe region 1715 and the fringe region 1725. When the user designates a position in the fringe region 1715, the CPU 101 preferably enlarges the shape of the pointing region 1760 into the second display region 1720. The position of the pointer image 1750 is shown inside the first display region 1710. However, in this scenario, the CPU 101 preferably enlarges the shape of the pointing region 1760 in the second display region 1720 as well as the first display region 1710.

As noted above, the image of the second display region 1720 is displayed in the second display 1740. Hence, the user does not need to move the touch pen over the second display 1740 in order to designate or capture the object 1800B. Accordingly, botheration of moving the touch pen 1790 between the first display 1730 and the second display 1740 can be mitigated.

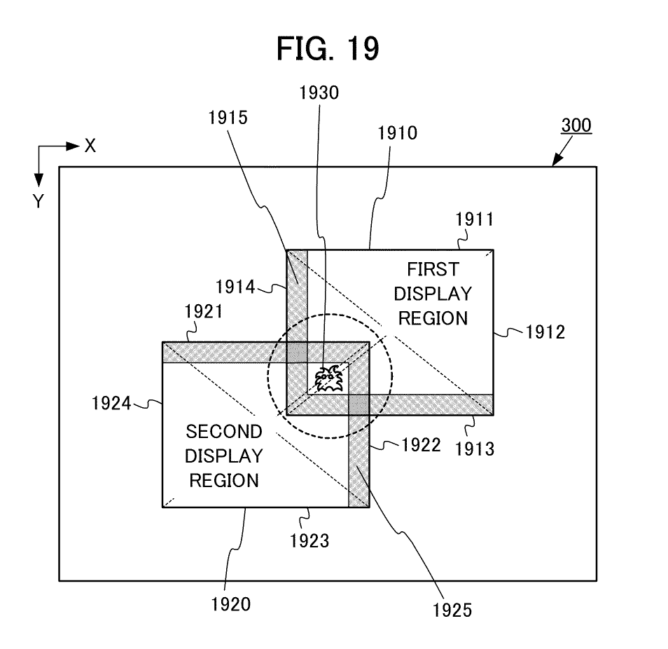

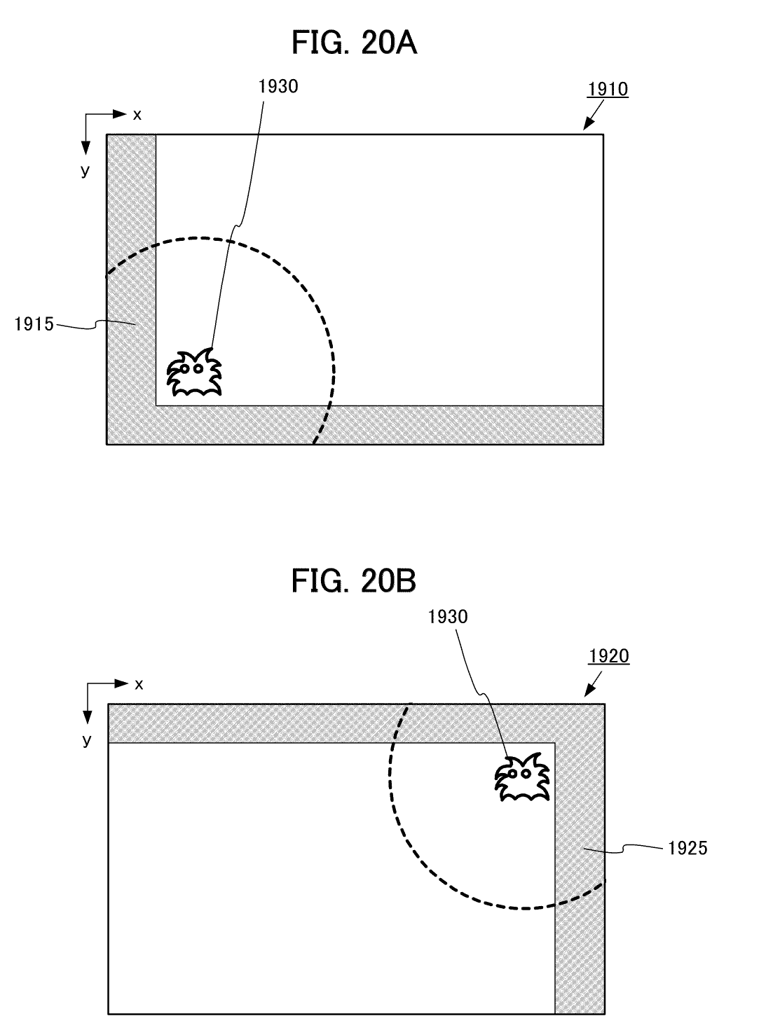

The CPU 101 may display a message 1850 in the first display 1730 indicating that the object 1800B has been selected. The CPU 101 may also display the pointer image 1750 in the first display 1730. However, the CPU 101 may also display the message 1850 in the second display 1740. While the first display region 1710 and the second display region 1720 are shown abutting without overlapping in FIG. 17A, the first display region 1910 and the second display region 1920 in FIG. 19 may also overlap. The first display region 1910 and the second display region 1920 may be squares composed of four sides as shown in FIG. 19. In addition, a single fringe region may correspond to two or more of these sides. Alternatively, a single fringe region may correspond to a portion of these sides. In FIG. 19, the first display region 1910 is shown as a region enclosed by the four sides 1911-1914. In addition, FIG. 19 also shows a second display region 1920 enclosed by the four sides 1921-1924. The fringe region 1915 is shown corresponding to the two sides 1913 and 1914 while the fringe region 1925 is shown corresponding to the two sides 1921 and 1922. The object 1930 is shown positioned in an area where the first display region 1910 and the second display region 1920 overlap. FIG. 20A shows yet another example of an image representing the first display region 1910 shown in FIG. 19. FIG. 20B is an example of an image representing the second display region 1920 shown in FIG. 19. The object 1930 is shown in both the first display region 1910 and the second display region 1920. The image showing the contents of the first display region 1910 is displayed in the first display 1730 shown in FIG. 17B, while the image showing the contents of the second display region 1920 is displayed in the second display 1740 shown in FIG. 17B.

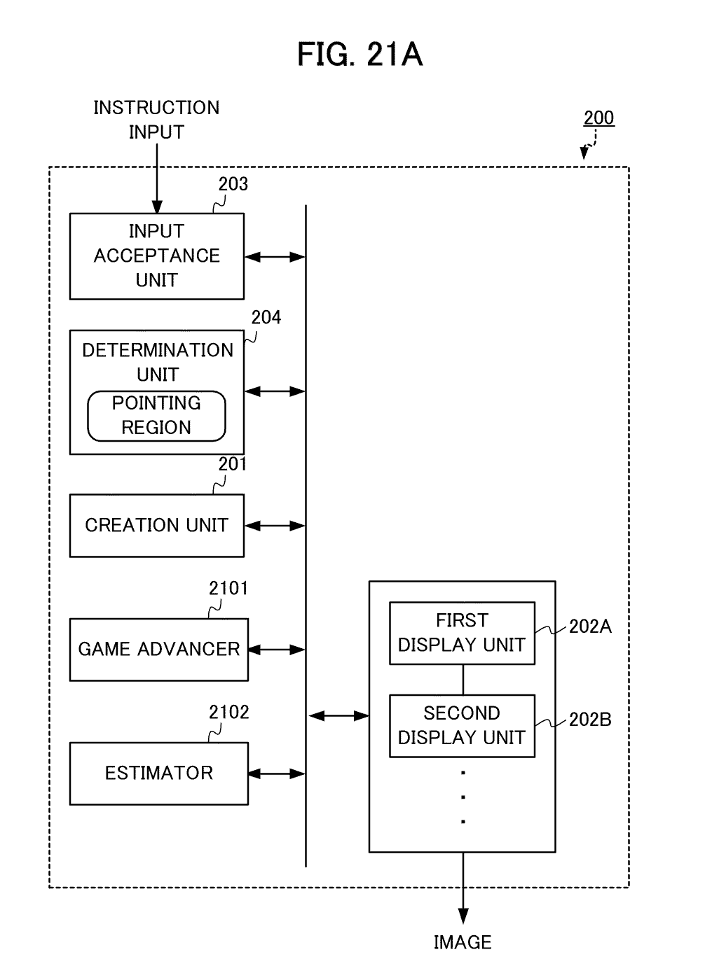

An eight preferred embodiment is described hereinafter. FIG. 21 shows the preferred elements of a determination apparatus 200. The determination apparatus 200 also preferably includes a game advancer 2101 and an estimator 2102.

The game advancer 2101 advances the game in the virtual space 300 in response to the instruction input received. The CPU 101 working in conjunction with 105, preferably functions as the game advancer 2101.

The estimator 2102 preferably estimates a user's skill level in a game. The CPU 101 preferably functions as the estimator 2102. The CPU 101 may store and update game history data in the external memory 106, etc, This information may be the number of times the game has been played, the time the game was played (or is being played), the time slot when the game is played (or is being played), the frequency of game playing, etc.

Based on the stored data, the CPU 101 may estimate whether the user's skill level is at or above a predetermined level. In addition, the CPU 101 may determine that the user is advanced if the user's skill level is at or above a predetermined level. Furthermore, the CPU 101 may determine that the user is a novice if the user's skill level is below a predetermined level.

The determination unit 204 of this preferred embodiment may enlarge the pointing region 500 when the following two conditions are satisfied: the position designated by the instruction input is contained in one of the fringe regions out of the one or more fringe regions established in the display region; and the estimator 2102 estimates that the user is a novice. The display region may be displayed by a plurality of display units 202.

A program that operates the computer as all or a portion of the determination apparatus 200 may be distributed in a computer-readable recording medium such as a memory card, USB memory, CD-ROM, DVD, Magneto Optical disk, etc. In addition, the program may be installed on a computer that operates the preferred elements or executes the above processes. The program may also be stored in a disk apparatus mounted on a service apparatus on the Internet, and may also be downloaded to a computer by piling up on carrier waves.

As described above, the present application provides a determination apparatus, determination method and data storage medium suitable for facilitating designation of positions in the corners of a displayed screen. As would be understood by one skilled in the art, the present application is not limited to the above embodiments, since various variations or applications are possible. In addition, the various constituent elements of the above embodiments can be freely altered and rearranged.

Having described and illustrated the principles of this application by reference to one (or more) preferred embodiment(s), it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A determination apparatus comprising:
a creation unit that creates an image;
a plurality of display units, each of which displays a portion of the image in a display region having a fringe region;
an input acceptance unit that receives instruction input designating a position in a display region from among the plurality of display regions; and
a determination unit that assigns a pointing region at the position designated by the instruction input received;
(a) wherein the determination unit assigns a first size for the pointing region, when the position designated by the instruction input is not in the fringe region of the display regions; and
(b) wherein the determination unit assigns a second size for the pointing region, when the position designated by the instruction input is in the fringe region of the display region, the second size being larger than the first size.

2. The determination apparatus according to claim 1,
(a′) wherein the determination unit assigns the first size and a first shape for the pointing region when the position designated by the instruction input is not in the fringe region; and
(b′) wherein the determination unit assigns the second size and a second shape for the pointing region when the position designated by the instruction input is in the fringe region.

3. A determination apparatus according to claim 1, wherein the plurality of display units include a first display unit adjacent to a second display unit, the first display unit displaying a first display region having a first fringe region set within a predetermined first distance from an edge of the first display unit, the edge of the first display unit being the edge closest to a second display region displayed on the second display unit, the second display unit displaying a second display region having a second fringe region set within a predetermined second distance from an edge of the second display unit, the edge of the second display unit being the edge closest to the first display region displayed on the first display unit wherein
(b″) the determination apparatus assigns the second size for the pointing region when the position designated by the instruction input is in either the first fringe region or the second fringe region.

4. The determination apparatus according to claim 1, further comprising
an object selectable by a user; and,
an output unit that outputs data indicating that the object is contained within the pointing region.

5. The determination apparatus according to claim 4, further comprising:
a pointer image indicating the object to be selected by the user if it is contained within the pointer image;
(a′″) wherein the output unit displays the pointer image at a predetermined size when the position of the pointer image is not in the fringe region displayed by the plurality of display units; and
(b′″) wherein the output unit displays the pointer image at a predetermined enlarged size when the position of the pointer image is in the fringe region.

6. The determination apparatus according to claim 1,
(a′) wherein the determination unit assigns the first size for the pointing region when the position designated by the instruction input is not in the fringe region;
(b1) wherein the determination unit assigns the second size for the pointing region when the position designated by the instruction input is in the fringe region; and
(b2) wherein the determination unit assigns the first size for the pointing region when the position designated by the instruction input is in the fringe region and the position of the object is not in the fringe region.

7. The determination apparatus according to claim 1, further comprising:
a game advancer that advances a game in a virtual space in response to the instruction input;
an estimator that estimates a user's skill level;
(a′) wherein the determination unit assigns the first size for the pointing region when the position designated by the instruction input is not in the fringe region;
(b1) wherein the determination unit assigns the second size for the pointing region when the position designated by the instruction input is in the fringe region and the estimator estimates that the user's skill level is below a predetermined level; and
(b2) wherein the determination unit assigns the first size for the pointing region when the position designated by the instruction input is in the fringe region and the estimator estimates that the user's skill level is at a predetermined level or higher.

8. A determination method for facilitating positioning of objects in the corners of a displayed screen comprising:
a creating step of creating an image;
a display step of displaying a portion of the image in a display region, the display region having a fringe region;
a receiving step of receiving instruction input designating a position in a display region from among the plurality of display regions; and
a determination step of assigning a pointing region at the position designated by the instruction input received;
(a) wherein the determination step assigns a first size for the pointing region, when the position designated by the instruction input is not in the fringe region of the display regions; and
(b) wherein the determination step assigns a second size for the pointing region, when the position designated by the instruction input is in the fringe region of the display region, the second size being larger than the first size.

9. A data storage medium having stored thereon a plurality of executable instructions for causing a computer system to facilitate positioning of objects in the corners of a displayed screen, the executable instructions performing a method comprising:
creating an image to be exhibited to a user;
displaying a portion of the image on a plurality of display units;
receiving instruction input from the user designating a position in the image; and
assigning an pointing region at the position designated by the instruction input received;
(a) wherein a determination unit assigns a first size for the pointing region when the position designated by the instruction input is not in a fringe region of the display unit; and
(b) wherein the determination unit assigns a second size for the pointing region when the position designated by the instruction input is in the fringe region of the display unit, the second size is larger than the first size.
